(19) United States
(12) Patent Application Publication
(10) Pub. No.: US 2003/0167264 A1
(43) Pub. Date: Sep. 4, 2003

(54) Method, apparatus and program for image search

(76) Inventors: Katsuo Ogura, Tokyo (JP); Takasi Sanse, Tokyo (JP)

Correspondence Address: BIRCH STEWART KOLASCH & BIRCH, PO BOX 747, FALLS CHURCH, VA, 22040-0747, US

(21) Appl. No.: 10/377,694

(22) Filed: Mar. 4, 2003

(30) Foreign Application Priority Data
Mar. 4, 2002 (JP) 056765/2002

(51) Int. Cl. G06F 7/00

(52) U.S. Cl. 707/3

(57) ABSTRACT

In an image use system wherein image registration is received for use by users, images related to each other can be searched for efficiently. A keyword database stores story keywords and a plurality of search keywords related to each of the story keywords. When a search is carried out based on any one of the story keywords, all images added with the search keywords related to the story keyword are searched for, and a list of thumbnail images of the images that have been found are obtained as a search result.

### BACKGROUND OF THE INVENTION

1. Field of the Invention

The present invention relates to an image search method and an image search apparatus for outputting a result of a search for desired image data according to a search keyword. The present invention also relates to a program that causes a computer to execute the image search method.

2. Description of the Related Art

In the case of searching image storage means for desired image data, a search means conventionally searches for the image data according to a search keyword. By using such search means, desired image data can be easily found by a search according to the search keyword corresponding to the desired image data. For example, by inputting a keyword “sea” for a search, all images related to the search keyword “sea” can be found.

Meanwhile, an image use system for facilitating use of images such as image rental and image trade has been proposed. In this system, a content provider that provides images taken by a professional photographer or the like registers images, and the registered images are disclosed to the public.

In such a system, an image database is generated for the registered images and stored in an image storage server. A user who wishes to use the images is allowed to access the image storage server via a network so that the images can be provided to the user. The user accesses the image storage server in the image use system, and searches for a desired one of the images by referring to the image database. The user can purchase the image or ask for rental of the image, and can download image data via the network.

The image use system described above is open not only to professional users that use the images for commercial purposes but also to general users who use the images for private purposes. Therefore, any user can use the artistic images provided by the content provider by paying a predetermined charge if he/she registers himself/herself with the image use system. For content providers, use of the images can be facilitated, since the users can widely view the images provided by the provider.

In the image database in the image storage server, each of the images is stored in relation to a keyword used for a search (hereinafter referred to as the search keyword). Therefore, any user can find a desired one of the images related to the search keyword by carrying out a search using the search keyword while referring to the image database. The desired image can be found efficiently by use of a search method such as narrowing-down search, synonym search, and whole text search that searches all comments added to image data.

In the image use system described above, in the case where a photograph album or an advertisement (hereinafter referred to as an image collection) regarding a baseball tournament is generated by searching for images related to “baseball tournament”, for example, the images added with the search keyword “baseball tournament” can be found by using the search keyword “baseball tournament”. However, in the case of generating the image collection on the baseball tournament, not only the images in the tournament but also images of training, tools such as bats and groves, facial expressions of players after games, little league tournaments, and high school baseball tournaments are often searched for, so that the image collection has a story line. In a case like this, if the search keyword “baseball tournament” isused alone, the images having some relationship with the baseball tournament, such as the images of training and the like, are not found. Therefore, by carrying out sequential searches according to the various search keywords such as “training” and “baseball equipment” in addition to the “baseball tournament”, the images can be found. This image search is extremely inefficient, and hinders promotion of image use.

### SUMMARY OF THE INVENTION

The present invention has been conceived based on consideration of the above circumstances. An object of the present invention is therefore to efficiently search for images that are correlated to each other.

An image search method of the present invention comprises the steps of:

receiving a desired one of representative keywords among the representative keywords each of which is prepared for representing a plurality of search keywords;

searching for a desired portion of image data sets that is related to the search keywords represented by the desired representative keyword, by referring to keyword storage means for storing the representative keywords each in relation to the search keywords, and by referring to image storage means that stores the image data sets in relation to the search keywords; and

outputting a search result.

In the image search method of the present invention, thumbnail images represented by the desired portion of the image data sets may be output by being included in the search result.

In this case, the image search method of the present invention may further comprise the steps of:

receiving selection of a desired portion of the thumbnail images;

receiving a specification of storage destination for classifying each of the selected thumbnail images;

receiving an instruction to classify the selected thumbnail images; and

storing each of the selected thumbnail images in the storage destination that has been specified therefor, in response to the instruction.

In the image search method of the present invention, the representative keywords that have been prepared may be displayed so that the desired one of the representative keywords can be selected therefrom. The desired one of the keywords may be input in this manner.

In the image search method of the present invention, a desired one of the search keywords may be input so that the search result can be further narrowed down based on the search keyword that has been input.

An image search apparatus of the present invention comprises:

image storage means for storing image data sets in relation to search keywords for each of the image data sets;

keyword storage means for storing representative keywords each of which represents a plurality of the search keywords, by relating each of the representative keywords to the search keywords;

keyword input means for receiving an input of a desired one of the representative keywords;

search means for carrying out a search for a desired portion of the image data sets related to the search keywords represented by the desired representative keyword that has been input from the keyword input means, while referring to the keyword storage means and the image storage means; and

search result output means for outputting a result of the search by the search means.

In the image search apparatus of the present invention, the search result output means may output thumbnail images represented by the desired portion of the image data sets, by including the thumbnail images in the result of the search.

The image search apparatus of the present invention may further comprise:

instruction input means for receiving selection of a desired portion of the thumbnail images, for receiving a specification of storage destination for classifying each of the selected thumbnail images, and for receiving an instruction for classifying the selected thumbnail images; and

classification means for storing the selected thumbnail images by classifying each of the selected thumbnail images in the storage destination that has been specified therefor, in response to the instruction input from the instruction input means.

In the image search apparatus of the present invention, the keyword input means may display the representative keywords so that the input of the desired one of the representative keywords is received by receiving a selection of the desired one the representative keywords therefrom.

In the image search apparatus of the present invention, the keyword input means may receive an input of a desired one of the search keywords so that the search means, can further narrow down the search result, based on the search keyword that has been input.

The image search method of the present invention may be provided as a program to cause a computer to execute the method.

According to the present invention, the representative keywords that respectively represent a plurality of the search keywords are prepared and related to the search keywords. When the desired one of the representative keywords is input, the keyword storage means and the image storage means are referred to, and the desired portion of the image data sets added with the search keywords represented by the desired representative keyword is searched for and output as the search result. Therefore, by carrying out only one search based on the desired one of the representative keywords, the desired portion of the image data sets added with the search keywords represented by the desired representative keyword can be searched for. In this manner, an image search can be carried out efficiently.

Furthermore, according to the present invention, the thumbnail images represented by the image data sets that have been searched for may also be output as the search result. Therefore, the images found in the search can be confirmed at a glance.

Moreover, according to the present invention, the selection of the desired portion of the thumbnail images is received and the storage destination for classifying the selected thumbnail images is specified for each of the thumbnail images therein. In other words, in the case where the thumbnail images included in the search result need to be stored in classification, the storage destination is specified for each of the selected thumbnail images. When the instruction for classifying the selected thumbnail images is received, each of the selected thumbnail images is stored in the storage destination that has been specified therefor. Therefore, in the case where the thumbnail images need to be stored in classification, the storage destination can be specified for each of the thumbnail images. In addition, each of the thumbnail images is stored in the specified storage destination at once, in response to the instruction. In this manner, the thumbnail images can be classified efficiently.

In addition, according to the present invention, the representative keywords are displayed and the desired one of the representative keywords is selected therefrom. In this manner, the desired one of the representative keywords can be input easily.

According to the present invention, a desired one of the search keywords can be input and the search result can be narrowed down according to the search keyword that has been input. In this manner, an image search can be carried out in detail.

### BRIEF DESCRIPTION OF THE DRAWINGS

FIG. 1 is a block diagram showing the configuration of an image use system as an embodiment of the present invention;

FIG. 2 is a block diagram showing the configuration of an image storage server;

FIG. 3 shows the structure of a property information database;

FIG. 4 shows the structure of a keyword database;

FIG. 5 shows the structure of an image information database;

FIG. 6 shows the structure of a content provider information database;

FIG. 7 shows the structure of a user information database;

FIG. 8 shows the content of property information represented by property data;

FIG. 9 shows a state wherein labels are attached to a recording medium;

FIG. 10 is a flow chart showing procedures for content provider registration;

FIG. 11 shows a top page window;

FIG. 12 is a flow chart showing procedures carried out in image registration in this embodiment;

FIG. 13 is a flow chart showing procedures for an image search by a user in this embodiment;

FIG. 14 shows a top page window for professionals;

FIG. 15 shows an image search window;

FIG. 16 shows a search frame in detail (part 1);

FIG. 17 shows the search frame in detail (part 2);

FIG. 18 shows a detailed search window shown in the search frame;

FIG. 19 shows a search result window;

FIG. 20 shows a candidate box;

FIG. 21 shows a photography item window;

FIG. 22 shows a login window;

FIG. 23 shows the login window displayed in an operation frame;

FIG. 24 shows a detailed information window;

FIG. 25 shows a use history display window;

FIG. 26 shows an order box;

FIG. 27 shows an addressee confirmation window;

FIG. 28 shows an order content confirmation window;

FIG. 29 shows a button display frame wherein a Download button has been added;

FIG. 30 shows a button display frame wherein a Content provider Menu button has been added;

FIG. 31 shows a detailed information setting window for a content provider;

FIG. 32 shows a content provider management menu window;

FIG. 33 shows a time period input window;

FIG. 34 shows sales information represented by sales data;

FIG. 35 shows a rental management window;

FIG. 36 shows a button display frame wherein a management menu button has been added;

FIG. 37 shows a management menu window;

FIG. 38 shows a content provider management window;

FIG. 39 shows a category management window;

FIG. 40 shows a keyword window;

FIG. 41 shows an order type management window;

FIG. 42 shows a charge information downloading window;

FIG. 43 shows charge information represented by charge data; and

FIG. 44 shows a detailed information setting window for a manager.

### DESCRIPTION OF THE PREFERRED EMBODIMENT

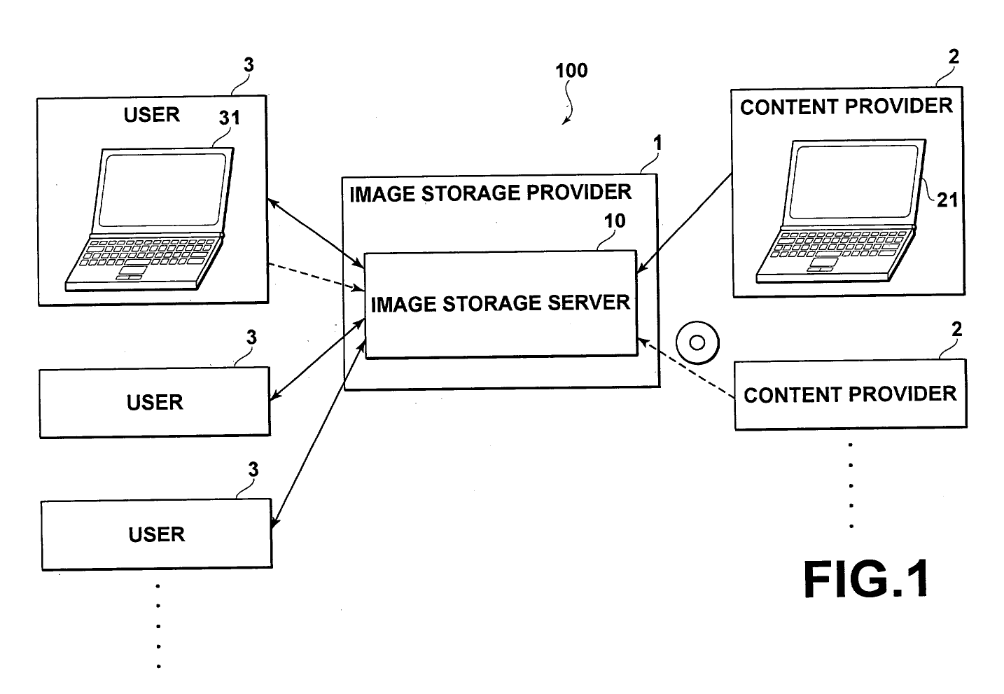

Hereinafter, an embodiment of the present invention will be explained with reference to the accompanying drawings. FIG. 1 is a block diagram showing the configuration of an image use system adopting an image search apparatus of an embodiment of the present invention. As shown in FIG. 1, an image use system 100 in this embodiment exchanges image data sets, films having images recorded thereon, posters, and the like, between an image storage provider 1, content providers 2, and users 3. The image storage provider 1 receives image registration by the content providers 2 such as professional photographers, and receives registration by the users 3 to view and to use images disclosed in the image use system 100.

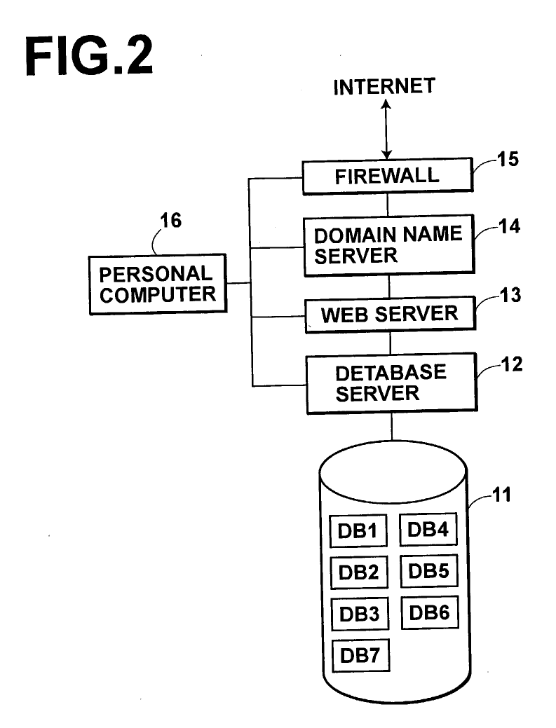

The image storage provider 1 has an image storage server 10. FIG. 2 is a block diagram showing a configuration of the image storage server 10. As shown in FIG. 2, the image storage server 10 comprises a storage unit 11, a database server 12 for controlling databases stored in the storage unit 11, a Web server 13 for generating a page to be displayed on a terminal such as a personal computer owned by any one of the users 3 or the content providers 2 when the terminal accesses the image storage server 10, a domain name server 14 for managing the domain name of the image storage server 10, a firewall 15 for protecting the image storage server 10 from an unauthorized access, and a personal computer 16 for managing the storage unit 11, the database server 12, the Web server 13, the domain name server 14, and the firewall 15.

The storage unit 11 comprises a large-capacity hard disc or a RAID that can store the databases and the image data sets whose sizes are large. The storage unit 11 stores an image storage database DB1 for storing the image data sets, a property information database DB2 for storing property information on the image data sets stored in the storage unit 11, a keyword database DB3 for storing story keywords each representing a plurality of search keywords and for storing the search keywords related to the respective story keywords, an image information database DB4 wherein the image storage database DB1, the property information database DB2, and the keyword database DB3 are related to each other, a content provider information database DB5 for storing information on the content providers 2, a user information database DB6 for storing information on the users 3, and a contest image database DB7 for storing image data sets representing images awarded in photograph contests.

The database server 12 manages all the databases DB1 to DB7 described above.

The image storage database DB1 comprises each of the image data sets whose registration was requested by the content providers 2, the file name of each of the images, the size of each of the image data sets, and basic image information representing basic information such as the date and time of update regarding each of the image data sets.

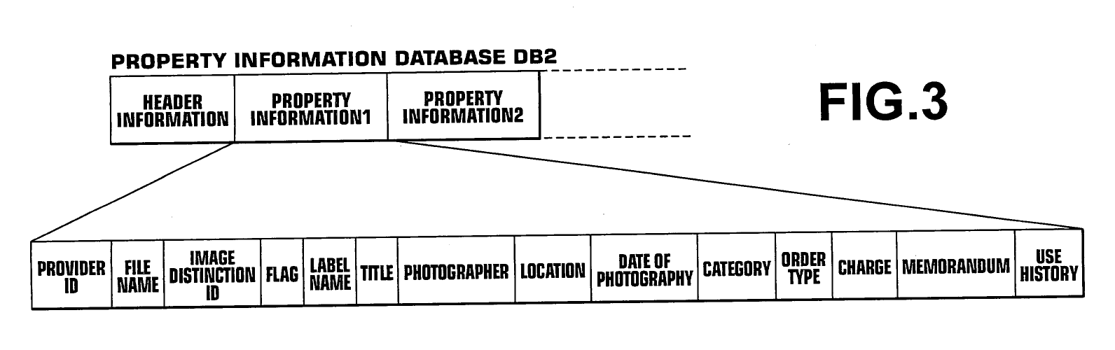

The property information database DB2 is generated for all the image data sets stored in the image storage database DB1, based on property data that will be explained below. The property information database DB2 comprises the property information on the image data sets and header information that manages the property information, as shown in FIG. 3.

The property information comprises items such as provider ID for specifying each of the content providers 2, the file name of each of the images to be registered, image distinction ID used by the corresponding content provider 2 for identifying each of the images, a flag showing whether or not a watermark has been added to each of the images (the flag takes a value “1” if the watermark is used, and takes a value “0” otherwise), a label name on a recording medium used in the case of image registration via the recording medium, a title of each of the images, a photographer of each of the images, the date of photography, a location of photography, a category or categories to which each of the images belongs, an order type for each of the images, a charge representing a charge for each of the images and a delivery charge, a memorandum describing the content of each of the images and a photography condition, and use history, for example. The file name of each of the images is the same as in the image storage database DB1. When a new image is registered or when one of the images is deleted or subjected to property information change, the property information database DB2 is updated.

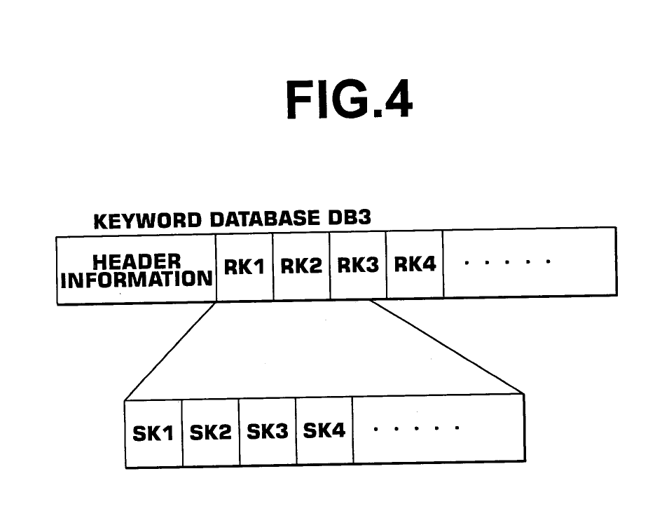

The keyword database DB3 comprises story keywords RKn (n: a natural number) and header information that manages the story keywords, as shown in FIG. 4. Each of the story keywords RKn is related to search keywords SKn (n: anatural number) represented by the corresponding one of the story keywords. The search keywords SKn are generated based on the title of each of the images or an image keyword extracted from the memorandum in the property information stored in the property information database DB2.

The story keywords represent a plurality of the search keywords. More specifically, if one of the story keywords is “baseball tournament”, the search keywords such as “training”, “baseball equipment”, “facial expressions after games”, “little league baseball tournament”, and “high school baseball tournament” are related to the story keyword. A manager at the image storage provider 1 manages the relationships between the story keywords and the search keywords.

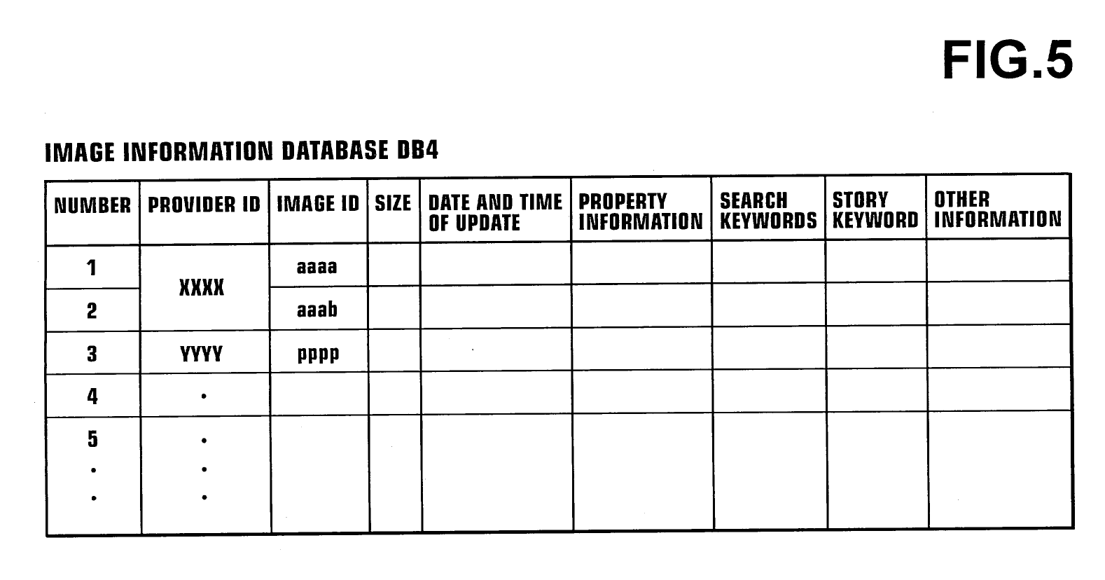

The image information database DB4 stores information by which the image storage database B1, the property information database DB2, and the keyword database DB3 are related to each other. In other words, as shown in FIG. 5, the image information database DB4 comprises items such as the provider ID, image ID corresponding to the file name of each of the images included in the property information, the size, the date and time of update, the property information, the search keywords, the story keyword or keywords, and other information.

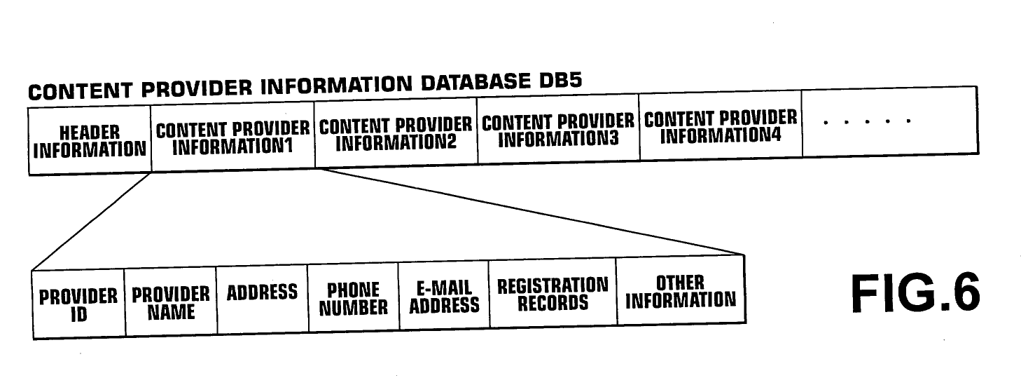

The content provider information database DB5 stores the information on the content providers 2 that have been registered with the image use system 100. As shown in FIG. 6, the content provider information database DB5 comprises content provider information and header information that manages the content provider information. When a new content provider 2 is registered, or the content of registration is changed or deleted, the content provider information database DB5 is updated. More specifically, the content provider information database DB5 comprises items such as the provider ID, the name, the address, the phone number, and the E-mail address of each of the content providers, registration records thereof, and other information.

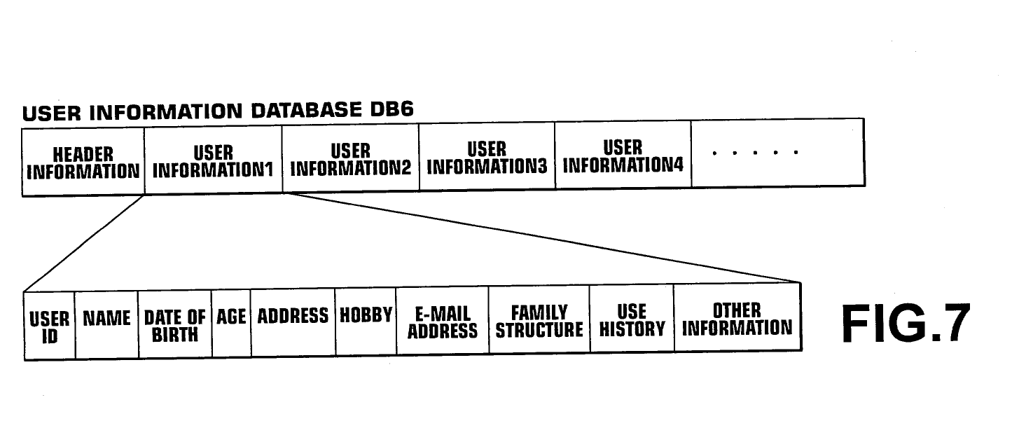

The user information database DB6 stores the information on the users 3 that have been registered with the image use system 100. As shown in FIG. 7, the user information database DB6 comprises user information and header information that manages the user information. When a new user 3 is registered or the content of registration is changed or deleted, the user information database DB6 is updated. More specifically, the user information comprises items such as the user ID, the name, the date of birth, age, the address, a hobby, and the E-mail address of each of the users 3, family structure thereof, use history regarding the image data sets, and other information.

The contest image database DB7 stores the image data sets representing the images awarded in the photograph contests (hereinafter the image data sets and the images are referred to as the contest image data sets and the contest images, respectively). The contest image database DB7 comprises each of the contest image data sets, the file name thereof, the data size thereof, the name of each of the contests in which each of the contest images was awarded, and information such as the date and time of update, as in the image storage database DB1.

The Web server 13 generates the page (a window) to be displayed on the terminal of one of the users 3 or one of the content providers 2 when the user 3 or the provider 2 accesses the image storage server 10. The Web server 13 also manages a Web site for the image storage server 10. In other words, the Web server 13 generates a window for registration with the image use system 100 (hereinafter referred to as the registration window) in response to a request from a new content provider 2 or a new user 3. For the users 3 and the content providers 2 that have finished registration, the Web server 13 generates a window for image search (hereinafter referred to as the image search window), a window for image selection, a window for receiving an order, and the like. The Web server sends data for displaying the windows to the terminal of the user 3 or the content provider 2 in access to the image storage server 10.

The personal computer 16 has a function of an image search apparatus of the present invention. The personal computer 16 controls the database server 12 and the Web server 13 so as to carry out an image search by referring to the keyword database DB3 and the image information database DB4 stored in the storage unit 11 according to an instruction from the image search window displayed on the terminal that has accessed the image storage server 10, and to output a search result.

When one of the content providers 2 registers a new image, or changes registration or deletes one or more of the images, the personal computer 16 controls the database server 12 so as to update the image storage database DB1, the property information database DB2, the keyword database DB3, and the image information database DB4 stored in the storage unit 11. When a new content provider 2 or user 3 is registered or when the registration is changed or deleted regarding any one of the providers 2 or the users 3, the personal computer 16 controls the database server 12 so as to update the content provider information database DB5 and the user information database DB6.

When one of the content providers 2 (hereinafter referred to as the content provider 2) registers a new image, the personal computer 16 refers to the contest image database DB7, and judges whether or not the image to be registered (hereinafter referred to as the image) is the same as one of the contest images. This judgment is made by calculating a correlativity value between the image and each of the contest images stored in the contest image database DB7 and by comparing the correlativity value with a predetermined threshold value. In the case where the correlativity value is equal to or larger than the threshold value, the image is judged to be the same as one of the contest images.

In the case where the image has been judged to be the same as one of the contest images, the personal computer 16 sends to the content provider 2 an E-mail message saying that the image matches one of the contest images. By judging whether or not the image to be registered is the same as one of the contest images, unauthorized use of the contest images by registration with the image use system 100 can be prevented.

Each of the images stored in the image storage server 10 maybe judged for a match with the image that is going to be registered, by referring not only to the contest image database DB7 but also the image storage database DB1. In this manner, if the image matches one of the images that has already been registered by one of the content providers 2, the image can be prevented from being stored again in the image storage server 10.

Instead of sending an E-mail message, a message or an audio message may be displayed on or output to the personal computer 16 for notifying the manager of the fact that the image is the same as one of the contest images. In this case, the manager of the image storage provider 1 notifies of the content provider 2 of the fact that the image agrees with the contest image.

Each of the content providers 2 has a personal computer 21 that acts as the terminal for accessing the image storage server 10 via a network such as the Internet. The content providers 2 register themselves with the image use system 100 and register their images with the image storage server 10 of the image storage provider 1, for wider use of their images.

Each of the content providers 2 may register the images by uploading the image data sets to the image storage server 10 after an access thereto from the personal computer 21. Alternatively, the images may be registered with the image storage server 10 by recording the image data sets in a recording medium such as a CD-R, a DVD-R, or an MO disc to be provided to the image storage server provider 1. In the latter case, the manager in the image storage provider 1 reads the image data sets from the recording medium with use of a recording medium drive (not shown), and registers the image data sets with the databases stored in the image storage server 10.

Each of the content providers 2 may request management of the images from the image storage provider 1 by providing the image storage provider 1 with the images such as films, posters, and panels to be rented or sold to the users 3. Alternatively, each of the content providers 2 may carry out management of the images so that the image storage provider 1 carries out only the image registration. In the latter case, thumbnail image data sets representing thumbnail images of the images to be registered are provided to the image storage provider 1, and the images are registered with the image storage server 10 based on the thumbnail image data sets.

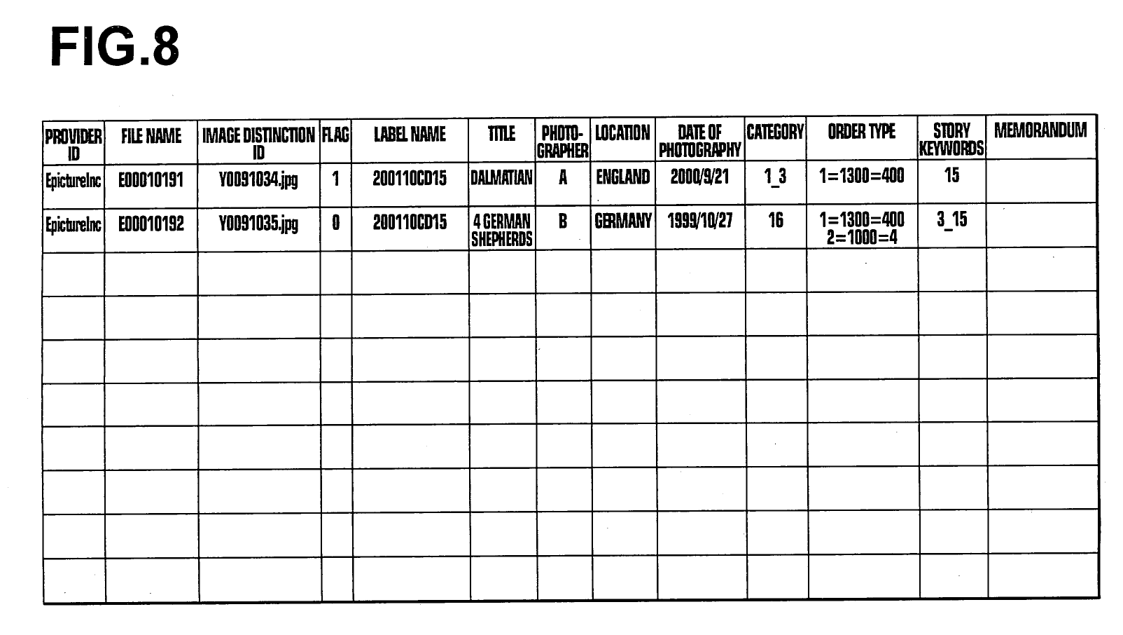

When the content provider 2 requests image registration from the image storage provider 1, the content provider 2 generates the property data that records the property information regarding the images to be registered, and provides the property data to the image storage provider 1. FIG. 8 shows the content of the property information comprising the property data. As shown in FIG. 8, the property data are generated in a csv file format, for example. The property data include the provider ID for identifying the content provider 2, the file name of each of the images to be registered, the image distinction ID used by the content provider 2 for identifying each of the images, the flag showing whether or not each of the images has been added with a watermark (the flag takes a value “1” if the watermark has been added, and takes a value “0” otherwise), the label name on the recording medium in the case of the image data sets being recorded in the recording medium, the title of each of the images, the photographer of each of the images, the location of photography, the date of photography, the category or categories to which each of the images belong, the order type or types including the image charge and the delivery charge, a story representing the story keyword or keywords added to each of the images, and the memorandum. The property information database DB2 as well as the image information database DB4 are updated, based on the property data.

The provider ID is the ID issued to the content provider 2 upon registration with the image use system.

The categories are predetermined and added with numbers such as 1 for New Year, 2 for Christmas, 3 for snapshots, 4 for sports, 5 for scenery, and 6 for business, for example. The content provider 2 inputs the number or numbers of the category or categories to which each of the images belongs. In the case where more than one of the categories correspond to the image, the categories are input by being separated by underscores.

The order types are predetermined and added with numbers such as 1 for negative films, 2 for positive films, 3 for posters, and 4 for downloading, for example. The content provider 2 inputs the order type number or numbers for the image. In the case where more than one of the order types can be used, the order types are input by being separated by underscores. The image charge and the delivery charge are input following the order type number or numbers, by being separated from the order type number with an “=” sign.

The content provider 2 needs to generate the property data for each image registration. For example, if the image data sets are provided to the image storage provider 1 in the form of the recording medium, the property information corresponding to the property data is generated for all the image data sets in the recording medium, and recorded in the recording medium to be provided to the image storage provider 1.

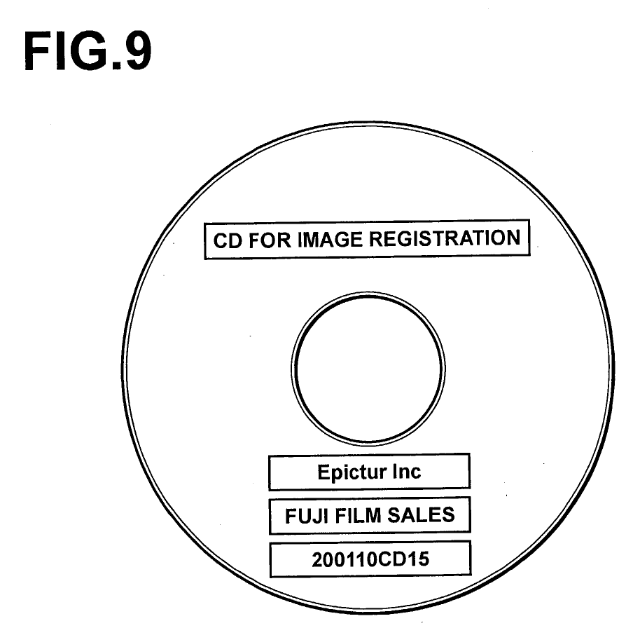

When the content provider 2 provides the image data sets to the image storage provider 1 in the form of the recording medium, labels need to be attached to the recording medium as shown in FIG. 9. More specifically, a label for indicating that the recording medium is used for image registration, a label describing the provider ID, a label describing the name of the content provider 2, and a label for identifying the recording medium are pasted on the recording medium.

Each of the users 3 has a personal computer 31 that acts as the terminal for accessing the image storage server 10 via the network such as the Internet. The users 3 are divided into general users who enjoy the images for private uses and professional users who use the images for commercial purposes. In this embodiment, both types of users are called the users 3.

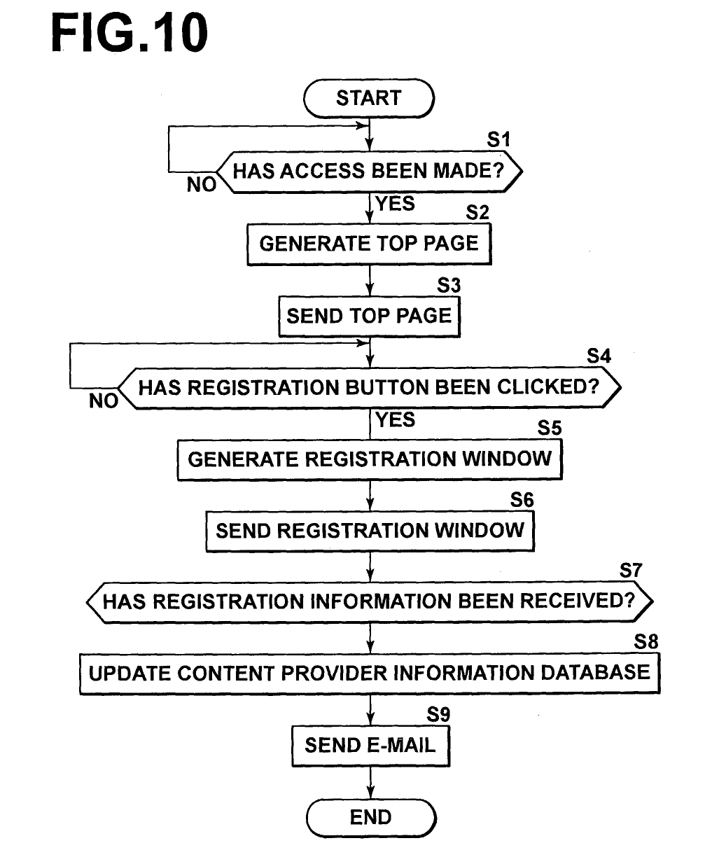

The operation of this embodiment will be explained next. FIG. 10 is a flow chart showing procedures for registration of the content provider 2. The content provider 2 carries out the registration procedures through an access to the image storage server 10 via the network.

Whether or not an access to the image storage server 10 has been made by the content provider 2 is judged (Step S1). If a result at Step S1 is affirmative, the Web server 13 generates a top page of the Web site for the image storage provider 1 (Step S2), and sends the top page to the personal computer 21 of the content provider 2 (Step S3). The top page is displayed as a top page window on the personal computer 21.

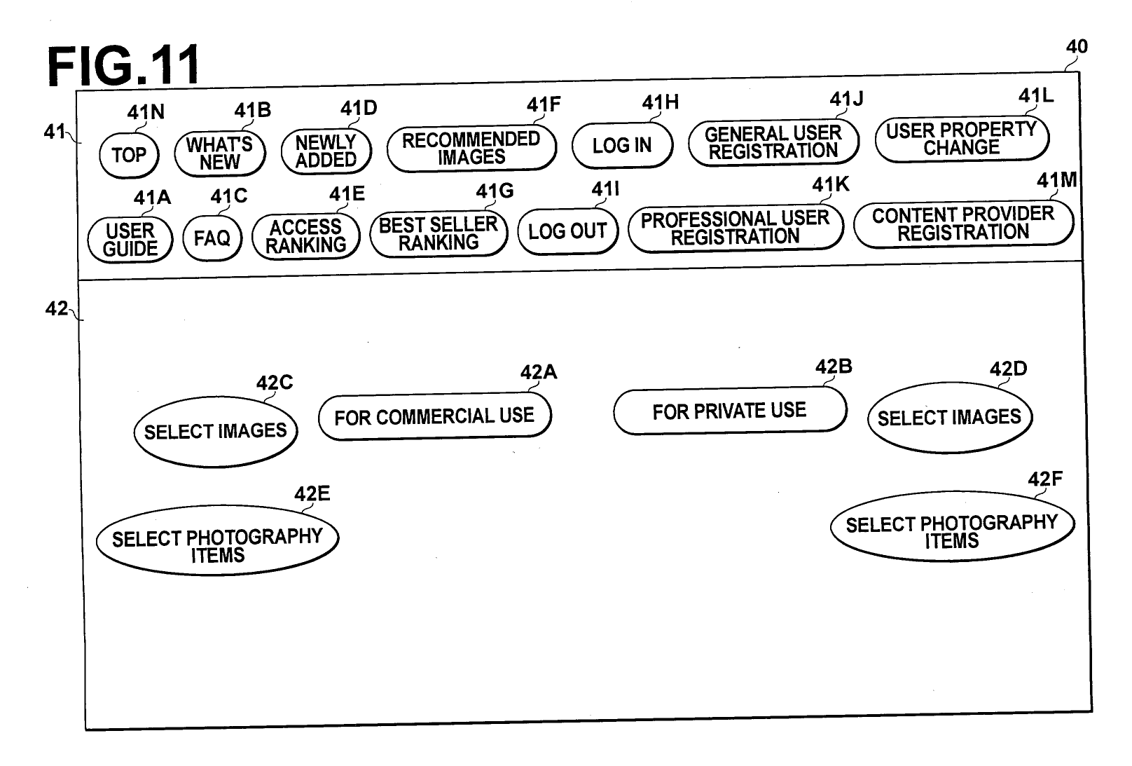

FIG. 11 shows the top page window. As shown in FIG. 11, the top page window has a button display frame 41 in which various buttons are displayed and an operation frame 42 in which various operations are carried out.

In the button display frame 41 are shown a “User guide” button 41A for displaying a user guide for use of the image use system 100, a “What's New” button 41B for displaying an update of the images, a “FAQ” button 41C for displaying frequently asked questions, a “Newly Added” button 41D for displaying information on images that have been added newly, an “Access Ranking” button 41E for displaying an access ranking regarding the images that have been registered with the image use system 100, a “Recommended Images” button 41F for displaying images recommended by the image storage provider 1, a “Best Seller Ranking” button 41G for displaying a best seller ranking regarding the images, a “Log In” button 41H for the registered users 3 to log in, a “Log Out” button 41I for logging off the system 100, a “General User Registration” button 41J for the general users 3 to display a registration window, a “Professional User Registration” button 41K for the professional users 3 to display a registration window, a “User Property Change” button 41L for the registered users 3 to display a window for changing the user property information thereof, a “Content Provider Registration” button 41M for a new content provider 2 to display a registration window, and a “TOP” button 41N for displaying the top page when another window is being displayed.

In the button display frame 41 in the top page window, only the “User guide” button 41A, the “What's New” button 41B, the FAQ button 41C, the “Log In” button 41H, the “General User Registration” button 41J, the “Professional User Registration” button 41K, and the “Content Provider Registration” button 41M are available before any one of the users 3 (hereinafter referred to as the user 3) logs in the image use system 100.

The operation frame 42 is used for carrying out the operations as will be explained later. In the operation frame are shown a “For Commercial Use” button 42A for the professional users, a “For Private Use” button 42B for the general users, a “Select Images” button 42C for displaying a window for the professional users to carry out image selection, a “Select Images” button 42D for displaying a window for the general users to carry out image selection, a “Select Photography Items” button 42E for displaying a window for the professional users to carry out selection from photography items, and a “Select Photography Items” button 42F for displaying a window for the general users to carry out selection from the photography items.

A new content provider 2 clicks the “Content Provider Registration” button 41M in the case of registration with the image use system 100. The image storage server 10 judges whether or not the “Content Provider Registration” button 41M displayed in the button display frame 41 in the top page window has been clicked (Step S4). If a result at Step S4 is affirmative, the Web server 13 generates the registration window (Step S5), and sends the registration window to the personal computer 21 of the new content provider 2 (Step S6).

The new content provider 2 inputs registration information comprising the name, the address, the phone number, and the E-mail address thereof, and clicks a “Submit” button in the registration window. The registration information is sent to the image storage server 10. The image storage server 10 judges whether or not the registration information has been received (Step S7). If a result at Step S7 is affirmative, the content provider information database DB5 is updated (Step S8), and the registration is completed. An E-mail message notifying the new content provider 2 of the fact that the registration has been completed is sent to the new content provider 2 (Step S9) to end the procedure.

The new content provider 2 may request registration by sending to the image storage provider 1 a form for registration with the image use system 100 after filling in the form. In this case, the manager of the image storage provider 1 inputs the registration information on the new content provider 2 to the image storage server 10, in order to register the new content provider 2.

The new content provider 2 can carry out image registration with the image storage server 10 after the registration thereof has been completed in the above manner.

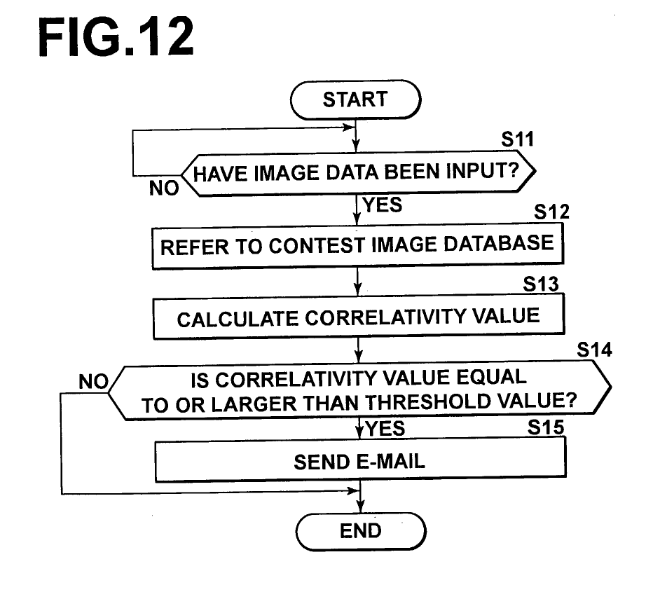

FIG. 12 is a flow chart showing procedures carried for image registration in this embodiment. The registration procedures are repeated for each of the images to be registered. When one of the image data sets to be registered is input to the image storage server 10 for image registration (Step S11), the contest image database DB7 is referred to (Step S12). The correlativity value is calculated between the image and each of the contest images stored in the contest image database DB7 (Step S13). The correlativity value is calculated by adding a difference between pixel values at corresponding pixel positions in the image and each of the contest images to be compared with. Each of the image data sets is input to the image storage server 10 via the network or by being read from the recording medium with use of the recording medium drive of the personal computer 16.

Whether the correlativity value is equal to or larger than the predetermined threshold value is judged (Step S14). If a result at Step S14 is negative, the image is judged to be different from the contest images and the procedure ends. If the result at Step S14 is affirmative, an E-mail message notifying the fact that the image is the same as one of the contest images is sent to the content provider 2 (Step S15) to end the procedure.

By judging whether or not the image to be registered is the same as any one of the contest images, any image stolen from among the contest images can be prevented from being registered with the image storage system 100. In this manner, the contest images can be prevented from being used illegally. The content providers 2 can also prevent from committing a crime such as copyright infringement due to erroneous registration of such an illegal image.

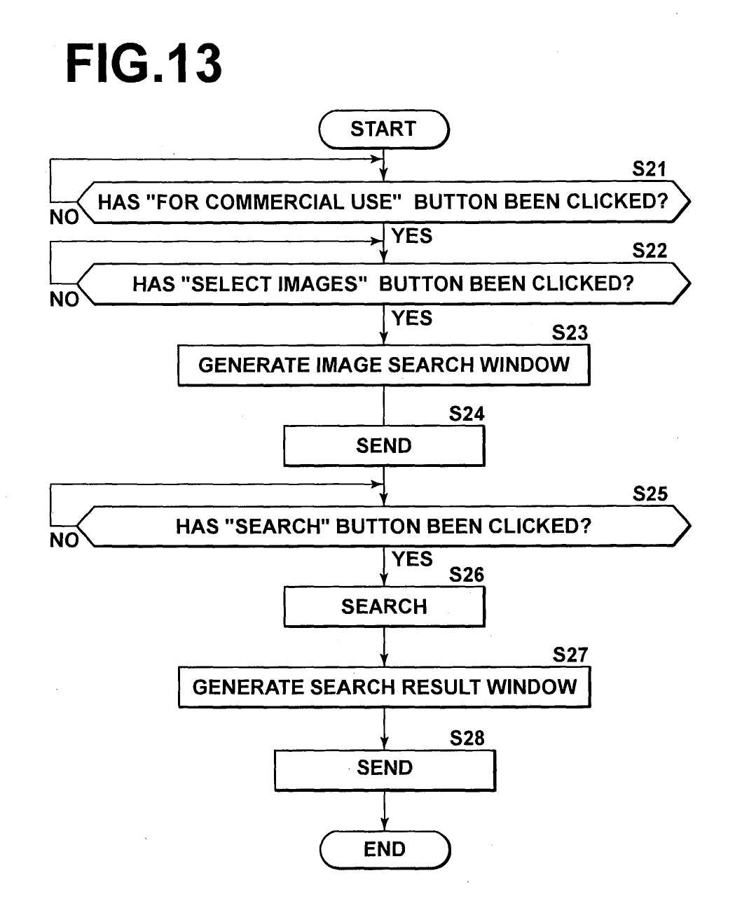

The user 3 accesses the image storage server 10 with use of the personal computer 31, and can carry out an image search. FIG. 13 is a flow chart showing image search procedures carried out by the user 3 in this embodiment. The procedures that are carried out until the top page window 40 is displayed on the personal computer 31 of the user 3 are the same as the procedures from Step S1 to Step S3 in the flow chart shown in FIG. 10. Therefore, the procedures after the top page window 40 is displayed will be explained below. The user 3 clicks either the “For Commercial Use” button 42A or “For Private Use” button 42B, depending on his/her purpose.

Regardless of which button is clicked, the same procedures are carried out except for a color displayed in the following window and the order type to be clicked. Therefore, only the case of clicking the “For Commercial Use” button 42A will be explained below.

Whether or not the “For Commercial Use” button 42A has been clicked is firstly judged (Step S21). If a result at Step S21 is affirmative, a top page window for the professional users is displayed. If the “For Private Use” button 42B is clicked, a top page window for the general users having a different color from the top page window for the professional users is displayed.

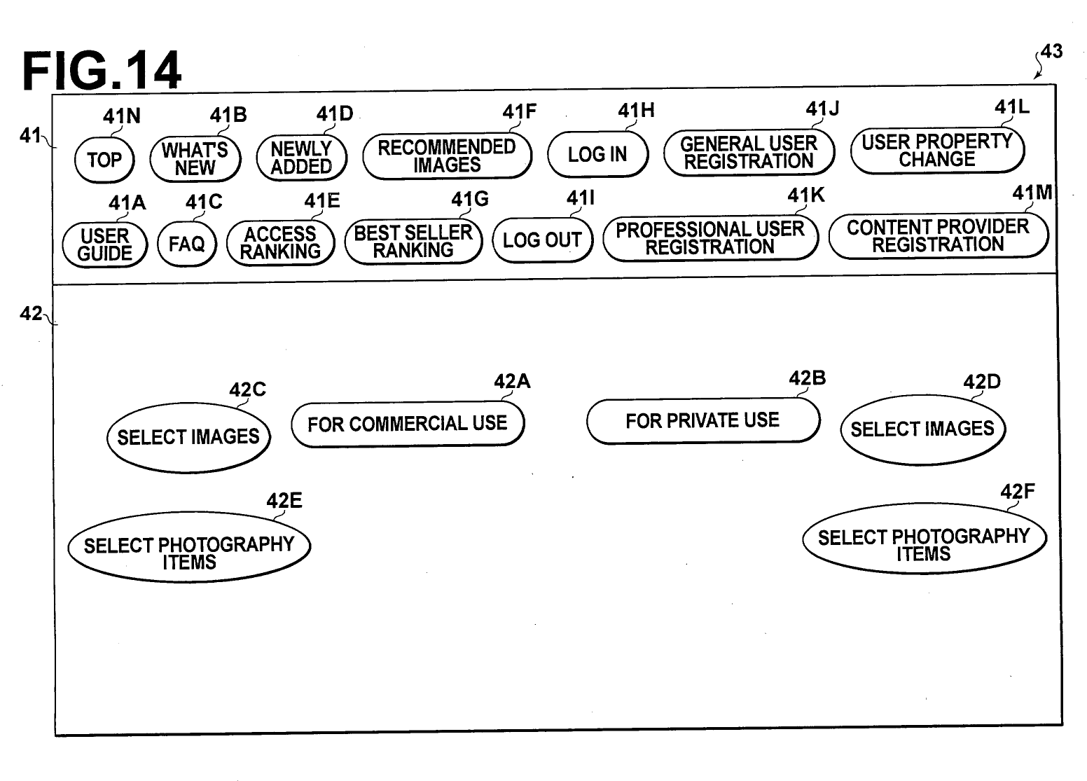

FIG. 14 shows the top page window for the professional users. As shown in FIG. 14, a top page window 43 is actually the same as the top page window shown in FIG. 11. However, before the user 3 logs in, only the “User guide” button 41A, the “What's New” button 41B, the “FAQ” button 41C, the “Newly Added” button 41D, the “Access Ranking” button 41E, the “Recommended Images” button 41F, the “Best Seller Ranking” button 41G, the “Log In” button 41H, and the “Professional User Registration” button 41K are available. In the case where the user 3 has already logged in the image use system 100, the “Log In” button 41H is not available but the “Log Out” button 41I is available. How the user 3 logs in the image use system 100 will be explained later.

Whether or not the “Select Images” button 42C has been clicked is then judged (Step S22). If a result at Step S22 is affirmative, the image search window is generated (Step S23), and sent to the personal computer 31 of the user 3 (Step S24). The image search window is displayed on the personal computer 31.

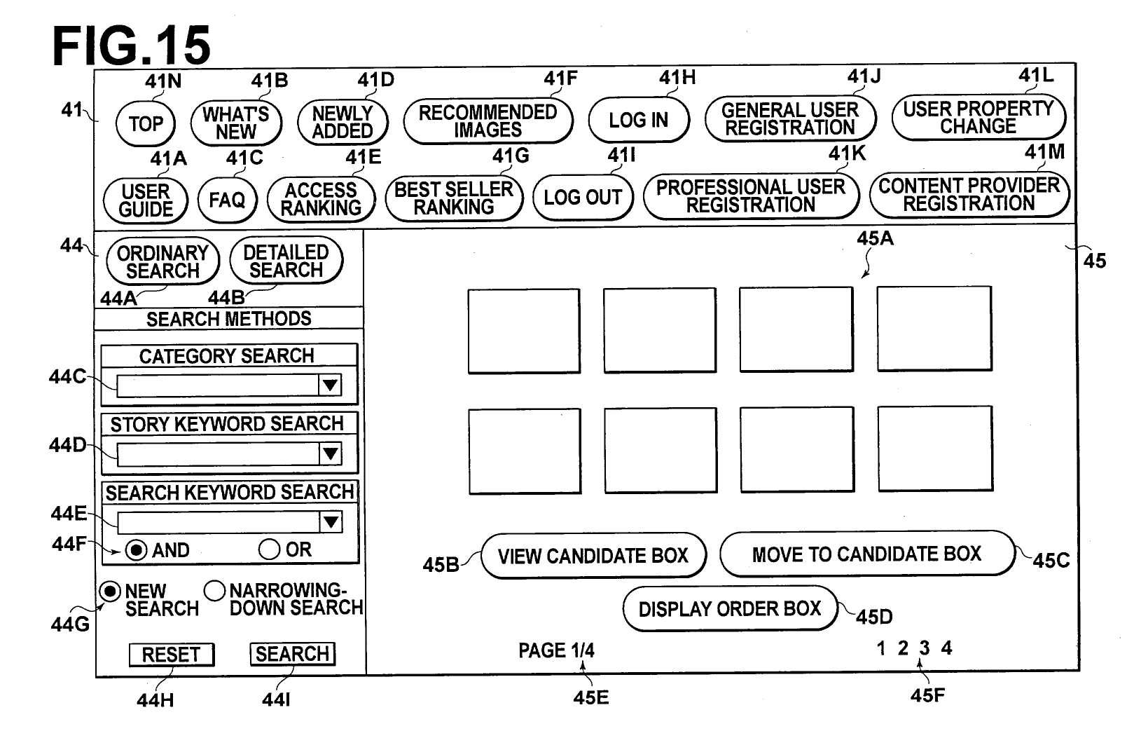

FIG. 15 shows the image search window. As shown in FIG. 15, the image search window has a button display frame 41, a search frame 44, and a search result display frame 45.

In the search frame 44 are shown an “Ordinary Search” button 44A for carrying out an ordinary image search as will be explained later, a “Detailed Search” button 44B for carrying out a detailed search, a pull-down menu 44C for a category search, a pull-down menu 44D for a story keyword search, a keyword input box 44E for inputting the search keyword or keywords used for a free keyword search, option buttons 44F for specifying an AND search and an OR search, option buttons 44G for specifying a new search or a narrowing-down search, a “Reset” button 44H for resetting a search condition, and a “Search” button 44I for carrying out the image search. In this embodiment, a window generated by clicking the “Ordinary Search” 44A button is used as a default window.

In the search result display frame 45 are shown a thumbnail image or thumbnail images 45A representing the image or images found among the images that have been registered, a “View Candidate Box” button 45B for viewing an image or images that have been selected and moved to one of candidate boxes as will be explained later, a “Move to Candidate Box” button 45C for moving a selected one of the thumbnail images to the candidate box, a “Display Order Box” button 45D for displaying an image or images that have been moved to an order box as will be explained later, a page display field 45E for displaying a page number of the thumbnail images being displayed, and a page moving field 45F that is clicked when the page is changed. (For the sake of simpler explanation, all thumbnail images are hereinafter referred to as the thumbnail images even if there is only one thumbnail image found through a search or the like.)

In this embodiment, a window in which thumbnail images of the images recommended by the image storage provider 1 are displayed is used as a default window for the search result display frame 45.

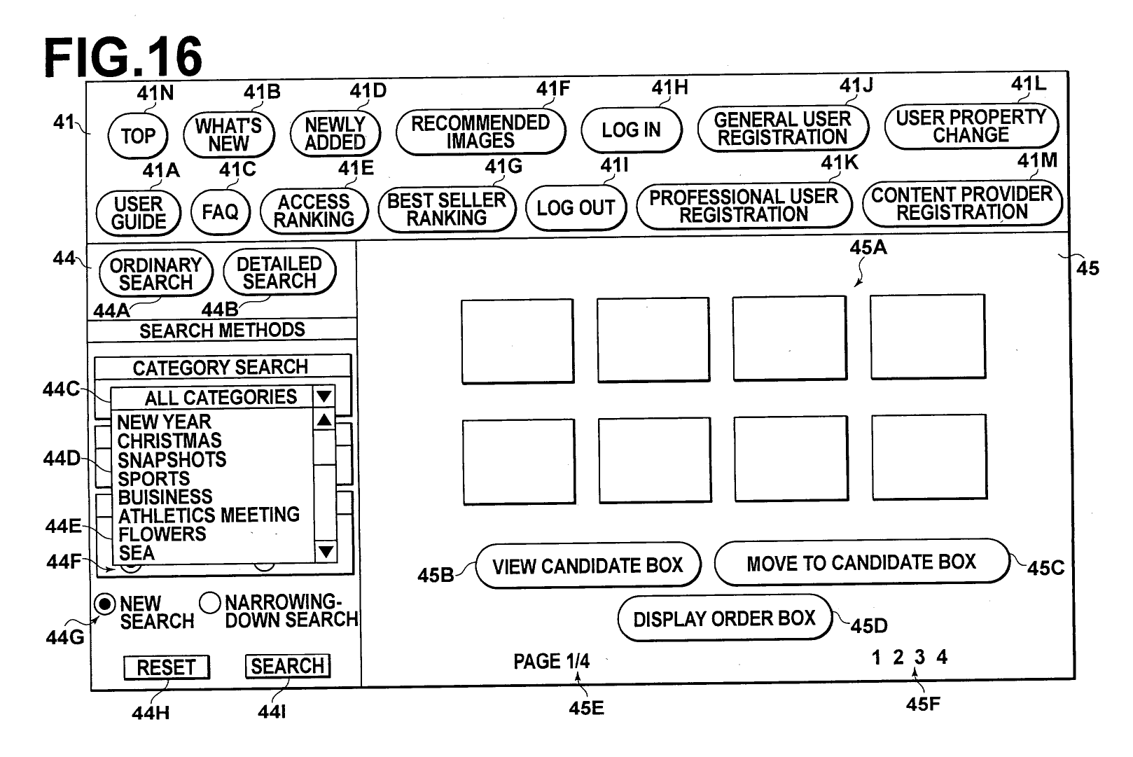

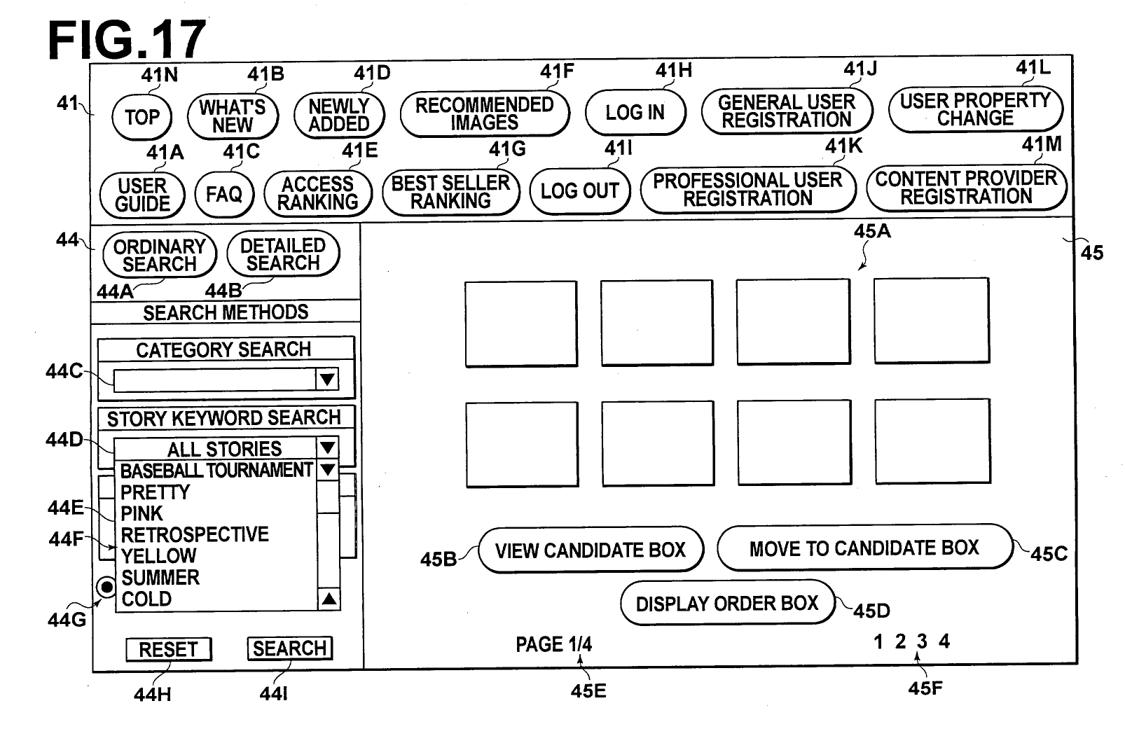

Hereinafter, the search frame 44 will be explained in detail. FIGS. 16 and 17 show details of the search frame 44 in the image search window. In the case where a category search is carried out, the user 3 clicks the pull-down menu 44C for the category search, and the categories to which the registered images belong are shown in the pull-down menu 44C, such as new year, Christmas, snapshots, and sports, as shown in FIG. 16. The categories correspond to the categories in the property information database DB2. The user 3 can select one of the categories to which the images to be searched for belong by clicking a desired one of the categories in the pull-down menu 44C. By using the pull-down menu 44C in this manner, the desired category can be input easily.

Meanwhile, as shown in FIG. 17, when the user 3 clicks the pull-down menu 44D for a story search, the selectable story keywords such as a baseball tournament, pretty, pink, retrospective, and yellow are shown in the pull-down menu 44D. The story keywords correspond to the story keywords RKn stored in the keyword database DB3. The user 3 can select one of the story keywords RKn by clicking a desired one of the story keywords that have been displayed in the menu. By using the pull-down menu 44D, the desired story keyword can be input easily.

By carrying out the search using the story keyword, the image information database DB4 is referred to, and all the images having the search keywords related to the selected story keyword are searched for. For example, if one of the story keywords “baseball tournament” is related to the search keywords “training”, “baseball equipment”, “facial expressions after games”, “little league baseball tournament”, and “high school baseball tournament”, all the images related to the search keywords “training”, “baseball equipment”, “facial expressions after tournaments”, “little league baseball tournament”, and “high school baseball tournament” are searched for. Therefore, by carrying out the story search using any of the story keywords, all the images related to the story keyword are searched for, and the images that can constitute the story can be searched for efficiently.

Meanwhile, if the user 3 inputs any one or more of the search keywords to the keyword input box 44E, the corresponding images are searched for, based on the search keyword or keywords that have been input. In the case where the search is carried out by the search keyword or keywords input in the keyword input box 44E, the search keywords in the image information database DB4 are referred to, and all the images related to the input search keyword or keywords are searched for. The user 3 can input more than one of the search keywords in the keyword input box by separating the search keywords by spaces. By selecting either one of the option buttons 44F, the user 3 can carry out an AND search or an OR search.

When the user 3 clicks the “Search” button 44I after specification of the category, the story keyword, and/or the search keyword or keywords, the images are searched for. When a new search is carried out, the option button 44G for new search is selected. When a narrowing-down search is carried out, the option button 44G for narrowing-down search is turned on. The image storage server 10 judges whether or not the “Search” button 44I has been clicked (Step S25). If a result at Step S25 is affirmative, the image information database DB4 stored in the storage unit 11 is referred to for the image search (Step S26). A search result window is then generated (Step S27), and sent to the personal computer 31 of the user 3 (Step S28) to end the image search procedures. In this manner, a search result is displayed in the search result display frame 45.

In the case where the user 3 further carries out a narrowing-down search after viewing the search result, the user 3 further specifies a category or a story to narrow down the search result. Alternatively, the search keyword or keywords for the narrowing-down search maybe input. Thereafter, the user 3 clicks the option button 44G for narrowing-down search and clicks the “Search” button 44I.

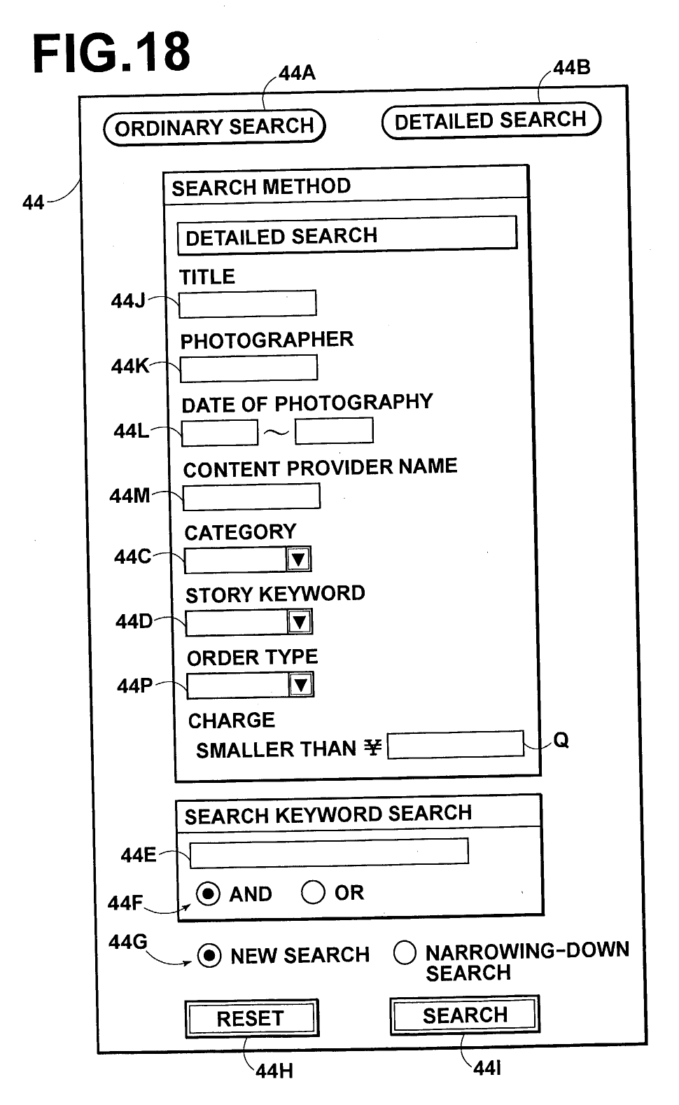

Meanwhile, when the “Detailed Search” button 44B is clicked, a detailed search window is displayed in the search frame 44. FIG. 18 shows the detailed search window shown in the search frame 44. In the detailed search window are displayed a title input box 44J for inputting an image title to be used for a search by the title, a photographer input box 44K for inputting a photographer to be used for a search according to the photographer, photography date input boxes 44L for inputting a range of the dates of photography for carrying out a search according to the date of photography, a content provider input box 44M for inputting one of the content providers 2 for a search according to the content provider, a pull-down menu 44P for carrying out a search according to one of the order types, and a charge input box 44Q for inputting a charge to be used for a search according to the charge, in addition to the buttons and the option buttons 44A to 44I shown in the search frame 44.

The order types refer to the types of the images to be provided to the user 3. The order types are different between the cases of commercial use and private use. For example, the order types that can be used for commercial purposes refer to posters, calendars, panels, and newspaper advertisements for rent, or downloading of the image data sets. The order types for private use refer to downloading of the image data sets, providing postcards, negative films, positive films, and photo frames, and providing characters that the users 3 can use, for example.

In the detailed search window, the user 3 can carry out a detailed image search by setting the title, the photographer, the photography date, the content provider, the order type, and the charge.

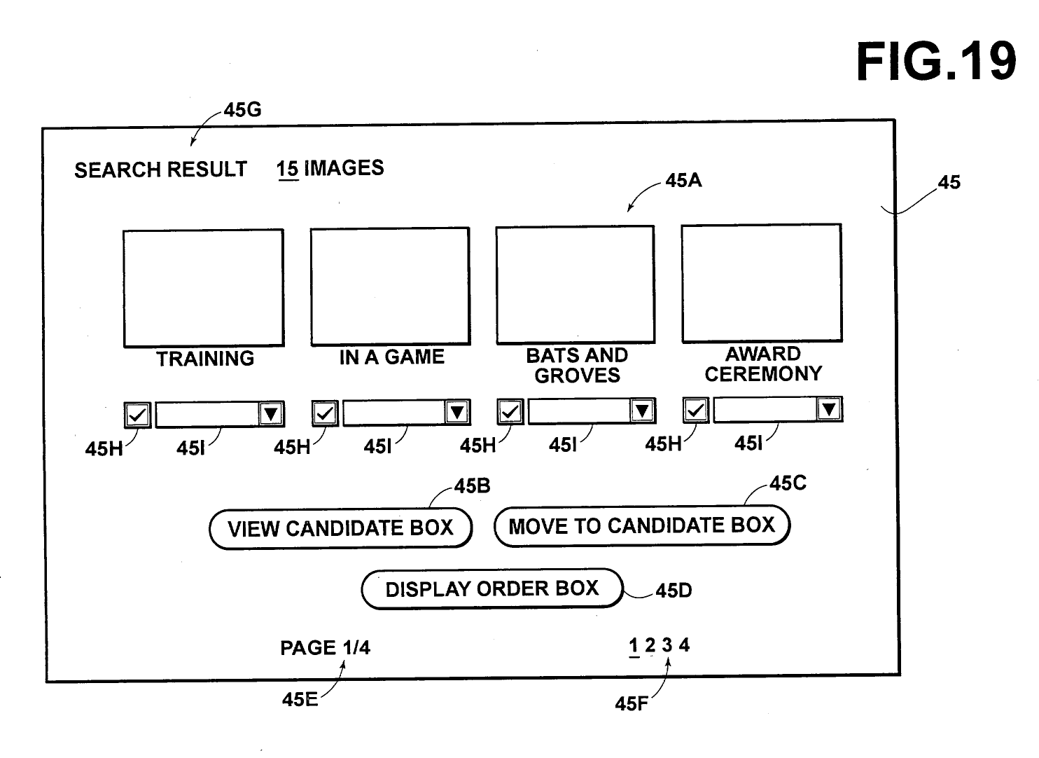

FIG. 19 shows the search result window. In FIG. 19, the window displayed in the search result display frame 45 is shown. As shown in FIG. 19, a quantity display field 45G for displaying the number of images that have been found is displayed, as well as the thumbnail images, the buttons and the fields 45A to 45F shown in the search result display frame 45. In the search result window are also displayed check boxes 45H for selecting the thumbnail images to be moved to the candidate boxes, and pull-down menus 45I for displaying the names of the candidate boxes.

The user 3 can understand the quantity and the content of the images that have been found, based on the quantity display field 45G and the thumbnail images 45A. In the case where all the thumbnail images that have been found are not shown in one page, all the thumbnail images 45A can be viewed if the page to be displayed is changed in response to clicking the corresponding page number in the page moving field 45F.

In the search result window, the user 3 selects one of the check boxes 45H corresponding to a desired one of the thumbnail images 45A to be moved to a desired one of the candidate boxes, and specifies the desired candidate box by using the pull-down menu 45I. A number representing each of the candidate boxes, such as Box 1, Box 2 and so on is displayed in the pull-down menu 45I. However, any candidate box having an arbitrary name may be input directly in the pull-down menu 45I. In this case, a new candidate box is generated and the selected thumbnail image 45A is moved thereto.

After the user 3 has selected the check box 45H and has specified the corresponding candidate box in the above manner for each of the thumbnail images 45A he/she wishes to move, the user clicks the “Move to Candidate Box” button 45C. The thumbnail images whose check boxes have been selected are then moved to the specified candidate boxes. In this manner, the thumbnail images 45A can be classified and stored efficiently in the candidate boxes by simply clicking the “Move to Candidate Box” button 45C.

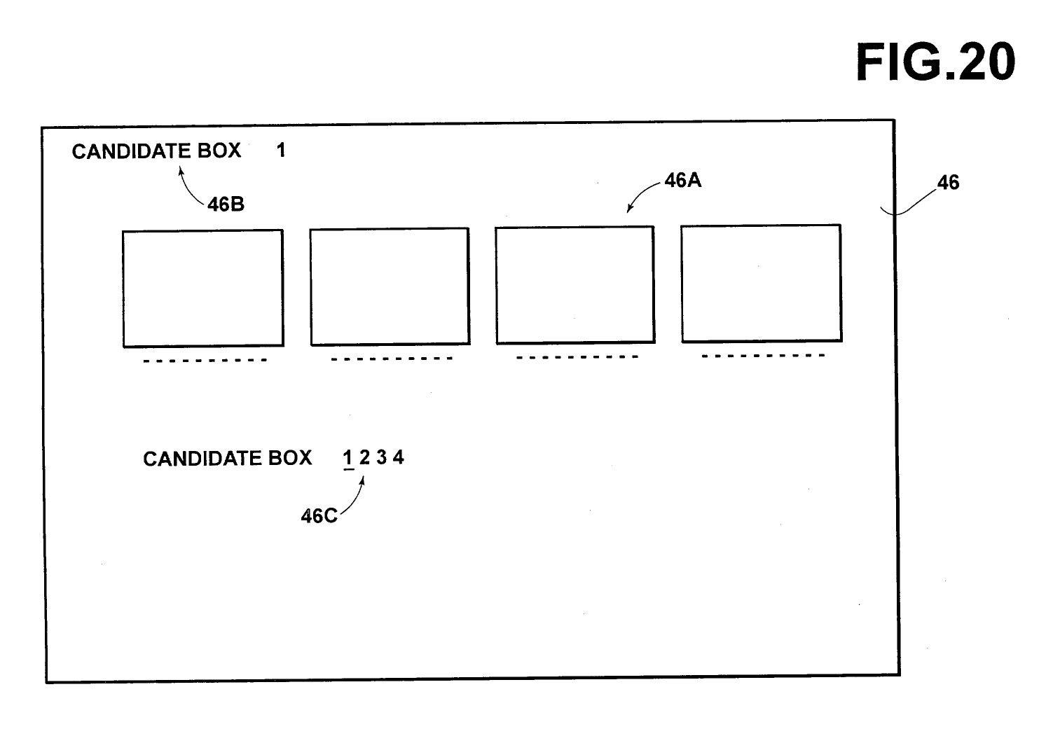

In the case where the user 3 wishes to view the thumbnail images 45A that have been moved to any one of the candidate boxes, the user clicks the “View Candidate Box” button 45B. The candidate box is shown as a separate window on the personal computer 31. FIG. 20 shows the candidate box window. As shown in FIG. 20, a candidate box window 46 includes thumbnail images 46A moved thereto, a candidate box name display field 46B for displaying the name of the candidate box, and a candidate box specification field 46C used for specifying one of the candidate boxes to be displayed.

The user 3 can view the thumbnail images 46A that have been moved to the candidate box. By clicking the number of a desired one of the candidate boxes, the user 3 can also view the thumbnail images 46A moved thereto. In the case where the user 3 has generated a candidate box, the name of the candidate box is displayed in the candidate box specification field 46C.

The thumbnail images 45A that have been found through the image search are shown in the search result display frame 45. By clicking the “Newly Added” button 41D in the button display frame 41, the user 3 can also display in the search result display frame 45 a window for thumbnail images 45A of the images registered newly with the image storage provider 1. By clicking the “Access Ranking” button 41E, thumbnail images 45A of the images selected from the registered images, whose access frequencies from 1^{st} to 30^{th} place in the past year, are displayed in the search result display frame 45. The “access” refers to display of a detailed information window regarding the thumbnail images as will be explained later.

By clicking the “Recommended Images” button 41F, the user 3 can display thumbnail images 45A of the recommended images used as the default window in the search result display frame 45. By clicking the “Best Seller Ranking” button 41G, thumbnail images 45A of the images selected from the registered images, whose purchase frequencies are ranked from 1^{st} to 30^{th} place in the past year, are displayed in the search result display frame 45.

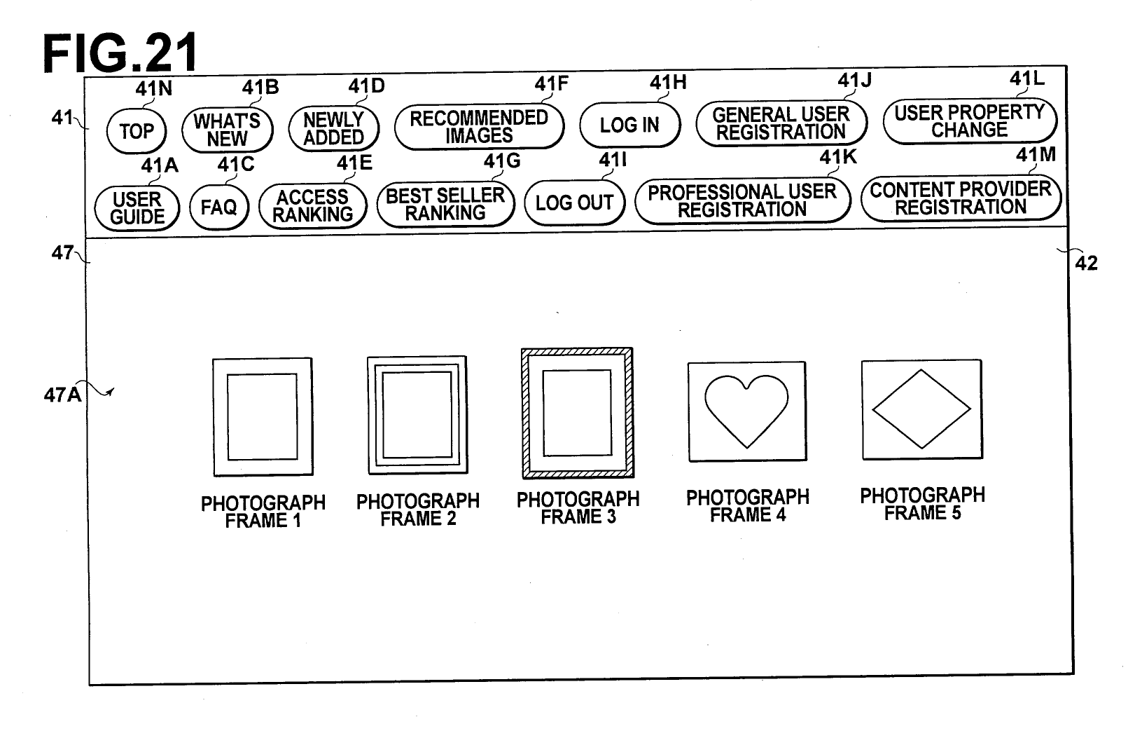

In the top page window 43, by clicking the “Select Photography Items” button 42E, a photography item window 47 is displayed in the operation frame 42, as shown in FIG. 21. Thumbnail images 47A of various kinds of photograph-related items such as photograph frames are shown in the photograph item window 47. By clicking a desired one of the thumbnail images 47A, an image corresponding to the selected item is searched for, and a thumbnail image display window of the searched image 47A is shown in the search result display frame 45.

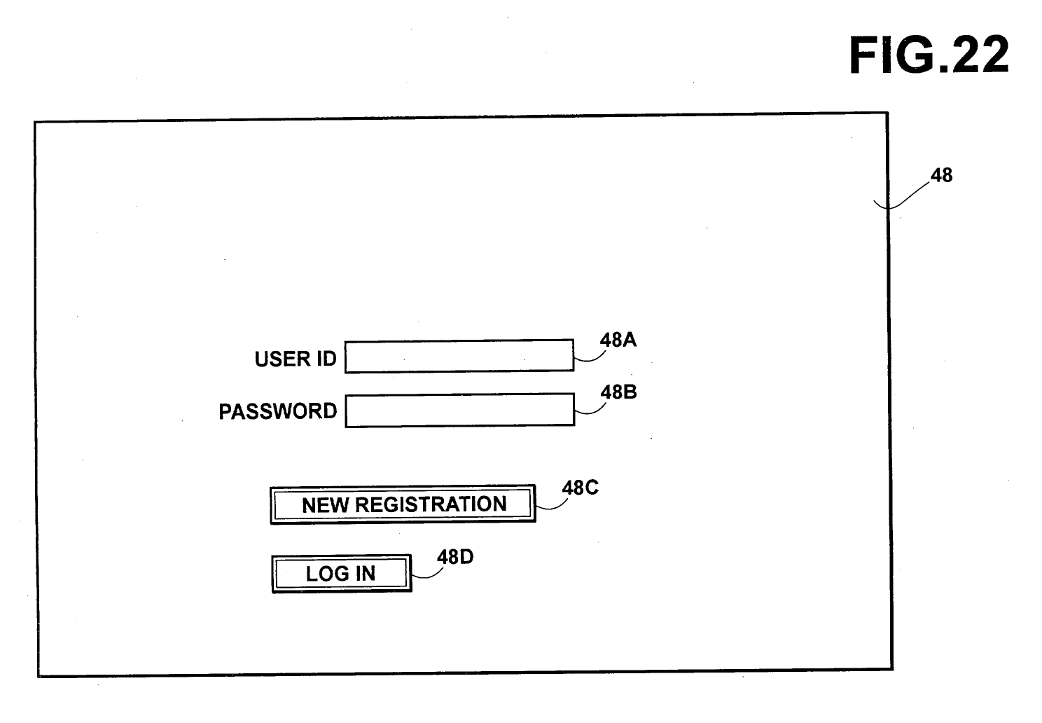

In the case where the user 3 wishes to view detailed information on any one of the thumbnail images 45A displayed in the search result display frame 45 or any one of the thumbnail images 46A displayed in the candidate box window 46, the user 3 needs to log in the image use system 100. Therefore, the user 3 clicks the “Log In” button 41H shown in the button display frame 41. In this manner, a login window shown in FIG. 22 is displayed as a separate window. As shown in FIG. 22, in a login window 48 are displayed a user ID input box 48A for inputting the user ID, a password input box 48B for inputting a password, a “New Registration” button 48C used for new user registration, and a “Log In” button 48D for logging in the image use system 100.

The user 3 inputs the user ID and the password in the user ID input box 48A and in the password input box 48B in the case where he/she has already registered himself/herself. Thereafter, the user 3 clicks the “Log In” button 48D to log in the image use system 100.

Meanwhile, in the case where the user 3 has not finished his/her registration, the user 3 clicks the “New Registration” button 48C. The registration window (not shown) for inputting information such as the name, the address, the phone number, the date of birth, and the E-mail address of the user 3, is displayed, and the user 3 inputs the information. The information is sent to the image storage server 10, and the user 3 can register himself/herself in this manner. The user 3 can select registration as either a professional user or a general user. The registration can be confirmed by an E-mail message sent from the image storage server 10 to the user 3 to describe the user ID and the password.

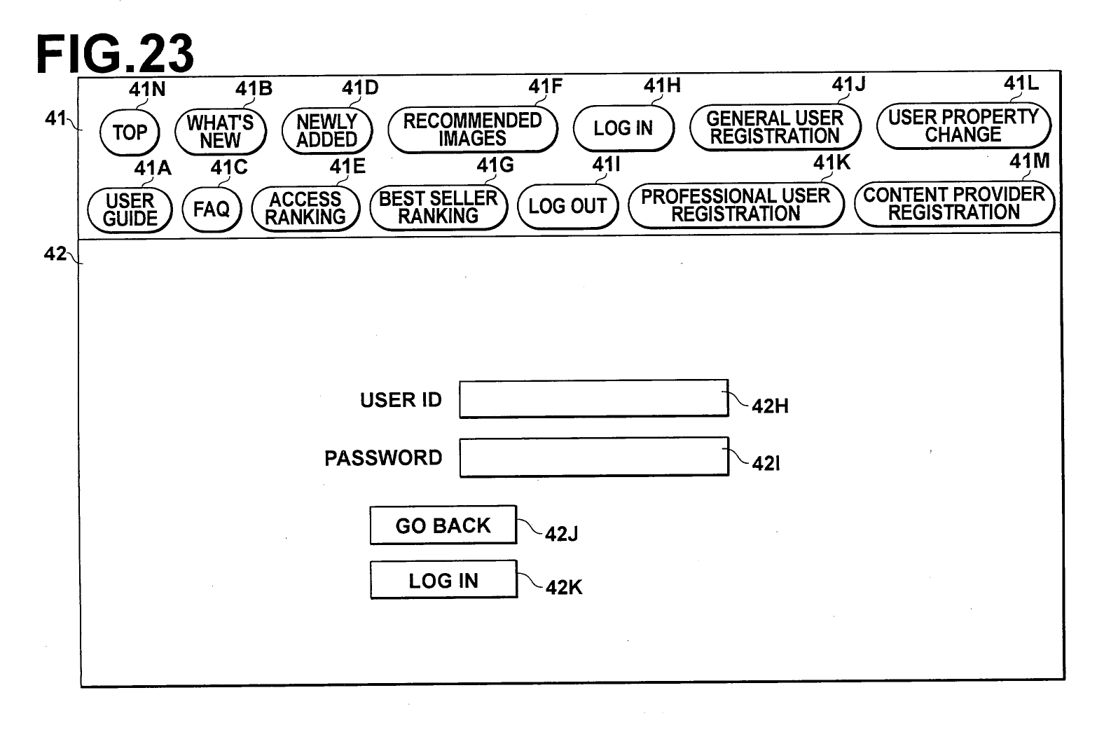

The user registration and login can also be carried out in the top page window 40. In other words, in the case where the user 3 has already finished his/her registration, the user 3 clicks the “Log In” button 41H in the button display frame 41. The operation frame 42 is displayed as shown in FIG. 23, wherein a user ID input box 42H, a password input box 42I, a “Go Back” button 42J for returning to a previous window, and a “Log In” button 42K for login are shown. The user 3 inputs the user ID and the password in the user ID input box 42H and in the password input box 42I, and clicks the “Log In” button 42K. In this manner, the user 3 can log in the image use system 100. The user 3 can carry out various kinds of operations such as the image search while he/she is logging in the system 100. At this time, whether the user 3 is a professional user or a general user is judged, based on the user ID. The window corresponding to the type of the user 3 (professional or general) is then displayed on the personal computer 31 of the user 3.

In the case where the user 3 has not finished his/her registration, the user 3 can register himself/herself by clicking the “Professional User Registration” button 41K or the “General User Registration” button 41J displayed in the button display frame 41. At this time, the registration window is different in the color and items to be input, depending on the difference between the professional users and the general users.

The user 3 who has already finished his/her registration with the image storage provider 1 can change his/her information by clicking the “User Property Change” button 41L shown in the button display frame 41.

After logging in the image use system 100 the above manner, if the user 3 clicks either one of the thumbnail images 45A or 46A in the search result window or in the candidate box window 46, the user 3 can view the detailed information on the image represented by the selected thumbnail image 45A or 46A. The detailed information window is displayed separately from the other windows, in response to clicking the desired thumbnail image 45A or 46A.

In the case where the user 3 has displayed the search result window or the candidate box window 46 by carrying out a search after logging in the image use system 100, the detailed information can be displayed only by clicking one of the thumbnail images 45A or 46A.

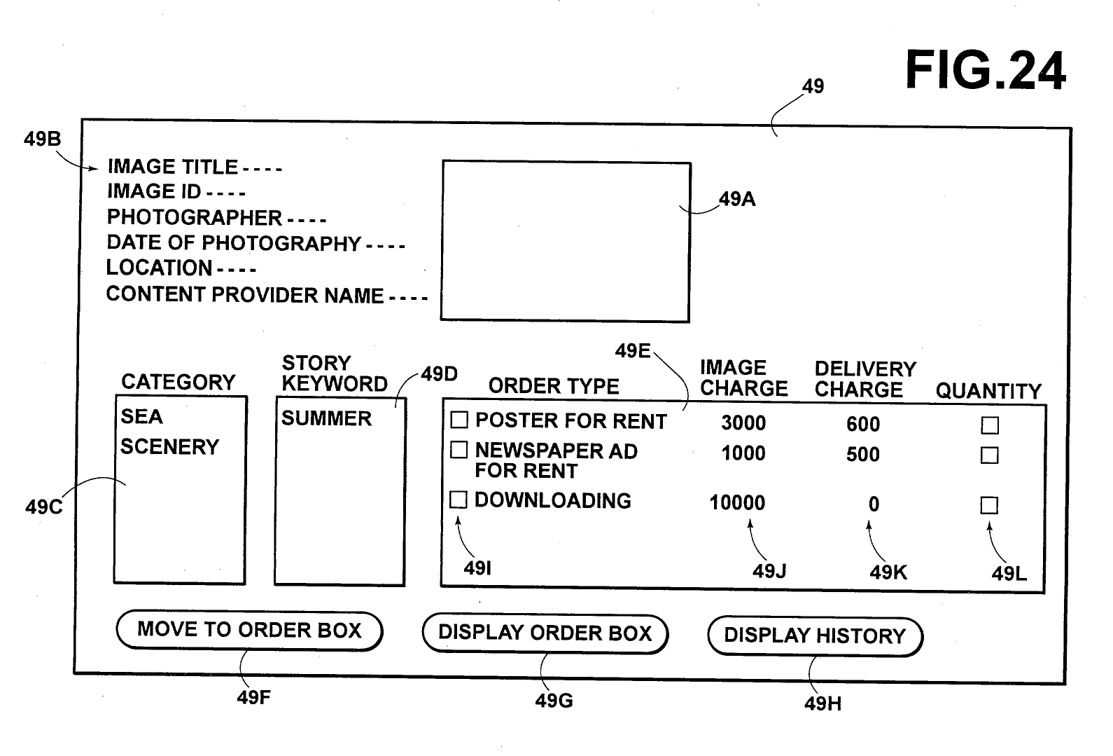

FIG. 24 shows the detailed information window. As shown in FIG. 24, in a detailed information window 49 are displayed an enlargement 49A of the selected image, a property information display field 49B for displaying the property information such as the title and the photographer of the image, a category display field 49C for displaying the category or categories the image belongs to, a story display field 49D for displaying the story keyword related to the image, an order type display field 49E for displaying the order type or types, a “Move to Order Box” button 49F for moving the image to the order box, a “Display Order Box” button 49G for displaying the image or images that have been moved to the order box, and a “Display History” button 49H for displaying the use history regarding the image.

In the order type display field 49E are shown check boxes 49I for specifying the order types such as downloading, and posters and newspaper advertisements for rent, a charge display field 49J for displaying the image charge according to the order types, a delivery charge display field 49K for displaying the charge for delivery, and quantity input fields 49L for inputting a quantity to be ordered.

The user 3 confirms the detailed information on the selected image by viewing the detailed information window 49, and clicks a desired one of the order type check boxes 49I if he/she wishes to place an order. The user 3 then inputs the quantity in the corresponding one of the quantity input boxes 49L, and clicks the “Move to Order Box” button 49F. In this manner, the image displayed in the detailed information window 49 is moved to the order box.

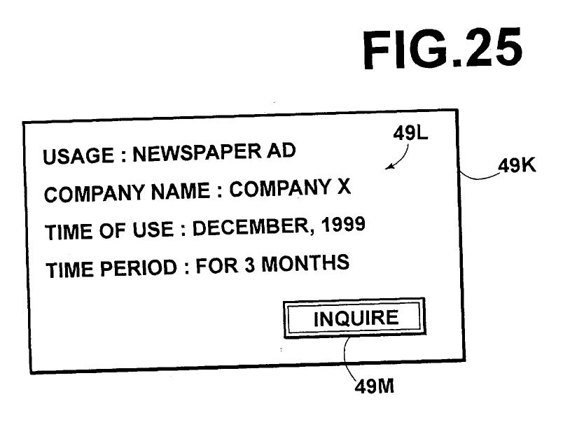

Meanwhile, if the user 3 clicks the “Display History” button 49H in the detailed information window 49, the property information database DB2 is referred to, and the use history on the image displayed in the detailed information window 49 is shown. FIG. 25 shows a use history display window. As shown in FIG. 25, a use history display window 49K has a use history display field 49L for displaying the use history and an “Inquire” button 49M for inquiring the use history in detail to the image storage provider 1 by using an E-mail message.

The use history shown in the use history display field 49L includes how the image was used, the name of a company that used the image, the time at which the image use was started, and a time period in which the image was used, for example.

Since the user 3 can confirm the use history on the image displayed in the detailed information window 49 by viewing the use history display window 49K, the user 3 can be prevented from using the same image that was used for an advertisement by his/her competitor, for example.

In the case where the user 3 wishes to know the use history in detail regarding the charge and the like, the user 3 clicks the “Inquire” button 49M to ask the image storage provider 1 for the use history in detail. Furthermore, depending on the users 3, a rank of use history that can be displayed may be determined so that the use history according to the rank can be displayed.

By clicking the “Display Order Box” button 49G in the detailed information window 49, the image or images that have been moved to the order box can be displayed. By clicking the “Display Order Box” button 45D in the search result window, the same images can also be displayed.

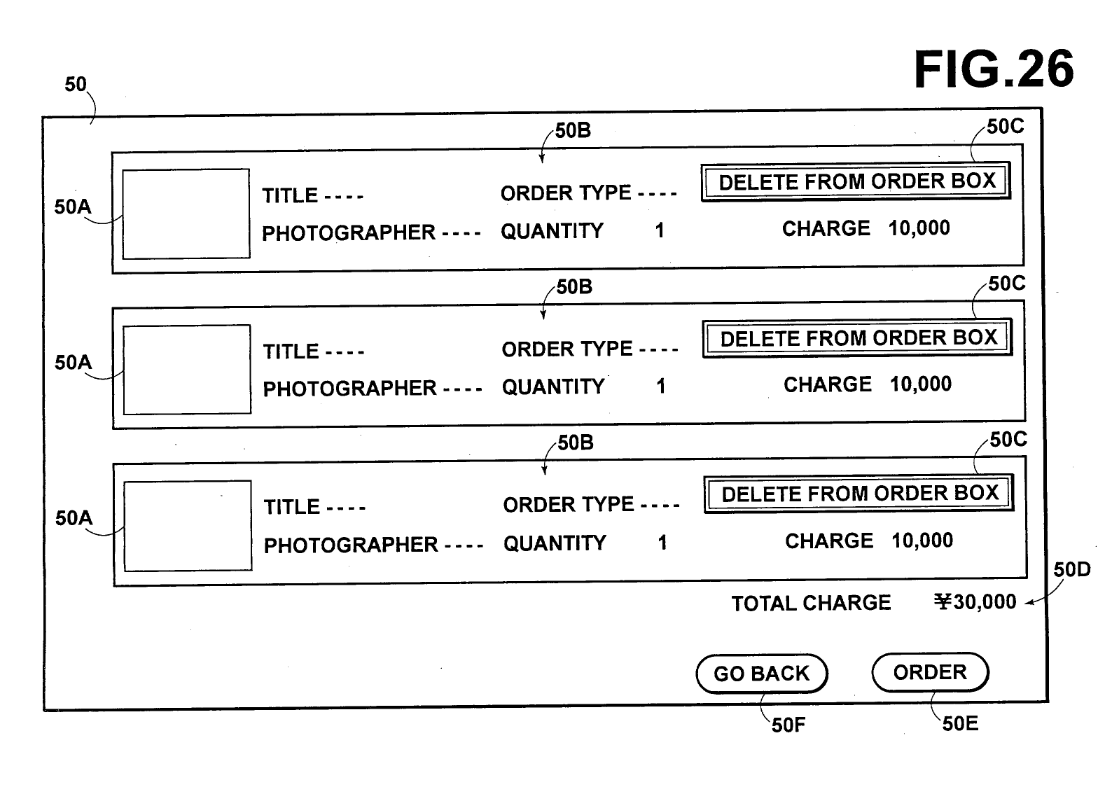

FIG. 26 shows the order box display window. As shown in FIG. 26, in an order box display window 50 are displayed thumbnail images 50A that have been moved to the order box, information display fields 50B for displaying the title, the photographer, the order type, the quantity and the charge for each of the images, and “Delete from Order Box” buttons 50C for deleting any one of the images from the order box. In addition to those buttons, a charge display field 50D for displaying a total charge, an “Order” button 50E for placing an order, and a “Go Back” button 50F for going back to the detailed information window 49 are also shown in the order box display window 50.

The user 3 can delete any one of the images by clicking the “Delete from Order box” button 50C in the information display field corresponding to the thumbnail image 50A to be deleted. By clicking the “Go Back” button 50F, the user can return to the detailed information window 49. By clicking the “Order” button 50E, an addressee confirmation window is displayed.

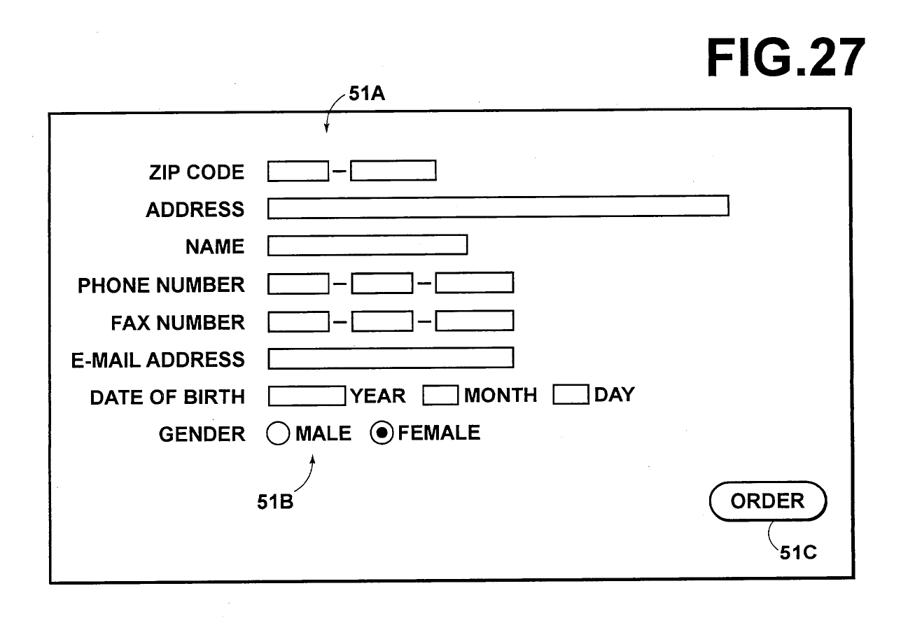

FIG. 27 shows the addressee confirmation window. As shown in FIG. 27, in an addressee confirmation window 51 are displayed input boxes 51A for inputting the zip code, the address, the name, the phone number, the fax number, the E-mail address, and the date of birth of the user 3, option buttons 51B for selecting the gender of the user 3, and an “Order” button 51C for placing the order. In the addressee confirmation window 51, the zip code, the address, the name, the phone number, the fax number, the E-mail address, and the date of birth of the user 3 have been input in the input boxes 51A in an initial state. The gender of the user 3 is also selected from the option buttons 51B.

In the case where the user 3 changes an addressee, the user 3 inputs the zip code, the address, the name, the phone number, the fax number, the E-mail address, and the date of birth of the addressee in the input boxes 51A, and selects either one of the option buttons 51B. After the addressee is confirmed or input, an order content confirmation window is displayed in response to clicking the “Order” button 51C.

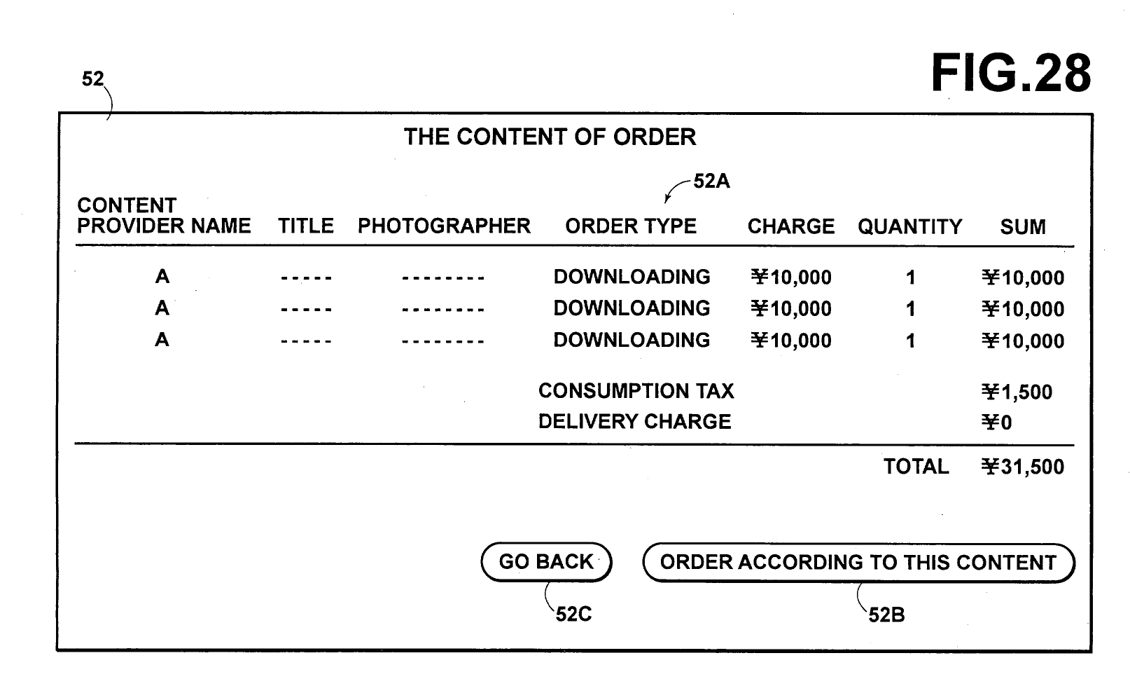

FIG. 28 shows the order content confirmation window. As shown in FIG. 28, in an order content confirmation window 52 are displayed an order content display field 52A for displaying the detail of the content of the order, an “Order according to this Content” button 52B for confirming the order, and a “Go Back” button 52C for going back to the addressee confirmation window 51. If the user 3 clicks the “Order according to this Content” button 52B after confirming the order content display field 52A, the order is placed and received by the image storage server 10. The image storage server 10 sends a confirmation E-mail message to the user 3 after reception of the order, and completes the order reception.

In the case where the order is for image rental, if the content provider 2 manages the requested images, the content provider 2 is notified of the order via an E-mail message or the like. The content provider 2 sends the requested image or images such as posters or negative films to the user 3. In the case where the images are managed by the image storage provider 1, the image storage provider 1 sends the requested image or images to the user 3. In this manner, the user 3 can obtain the requested images.

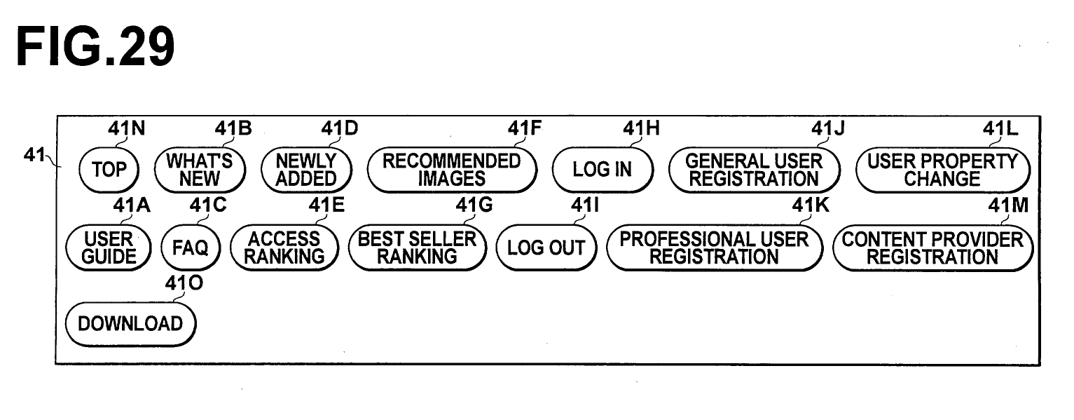

In the case where the images are to be obtained by downloading, a “Download” button 410 is added to the button display frame 41 for downloading, as shown in FIG. 29. In this case, the user 3 can download the image or images at any time within a predetermined time period after placing the order (such as 2 weeks after placing the order). For this reason, when the user 3 clicks the “Download” button 410, a list of images (thumbnail images) that have been ordered via downloading in the predetermined time period are shown. The user 3 can select any one or more of the images and can download the image data set or sets corresponding to the selected image or images.

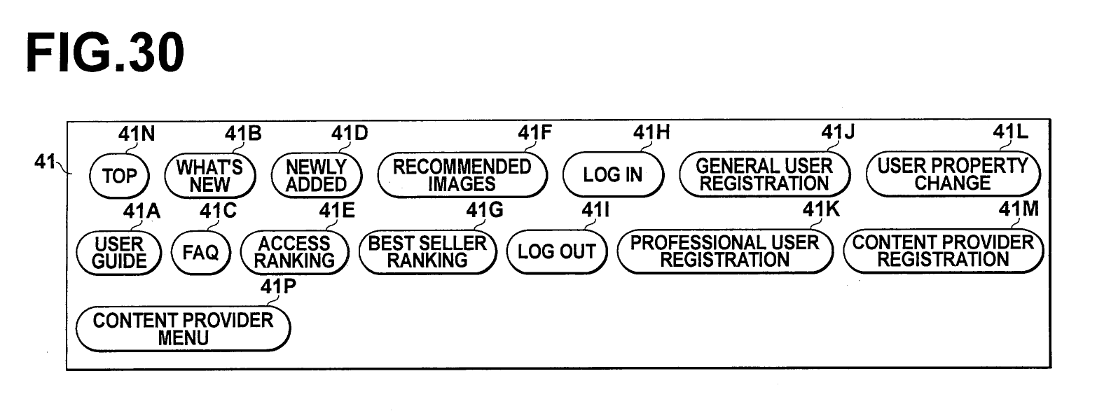

The content provider 2 can also log in the image use system 100 by using the provider ID thereof, like the user 3. When the content provider 2 logs in, a “Content provider Menu” button 41P dedicated to the content providers 2 is displayed in the button display frame 41, as shown in FIG. 30. Since the provider ID of the content provider 2 is different from the user ID of each of the users 3, the “Content provider Menu” button 41P is displayed only in the case where the ID that has been input is the provider ID.

The content provider 2 also displays the image search window by clicking either the “For Commercial Use” button 42A or the “For Private Use” button 42B shown in the top page window 40. In this window, the content provider 2 can search for a desired one of the images or display the detailed information therein. In the case where the image whose detailed information is being displayed was registered by the content provider 2, a detailed information setting window is displayed for the content provider 2.

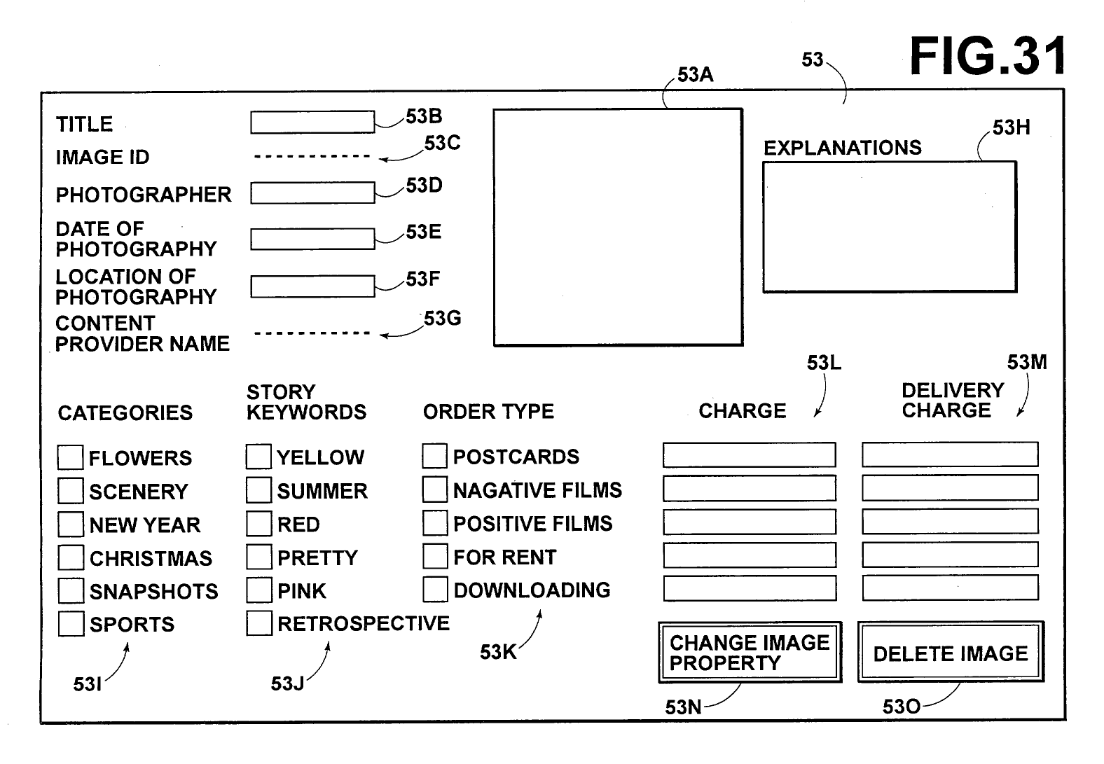

FIG. 31 shows the detailed information setting window for the content providers 2. As shown in FIG. 31, in a detailed information setting window 53, the content provider 2 can change the image property. In the detailed information setting window 53 are displayed an image 53A, a title input box 53B for inputting the title of the image, an image ID display field 53C for displaying the image ID, a photographer input box 53D for inputting the photographer of the image, a photography date input box 53E for inputting the date of photography, a photography location input box 52F for inputting the location of photography, a content provider name display field 53G for displaying the name of the content provider 2, an explanation input box 53H for inputting an explanation on the image, category check boxes 53I for setting the category or categories the image belongs to, story check boxes 53J for setting the story or stories of the image, order type check boxes 53K for setting the order type or types for the image, charge input boxes 53L for inputting the image charge corresponding to each of the order types, delivery charge input boxes 53M for inputting the delivery charge corresponding to each of the order types, a “Change Image Property” button 53N for changing the image property, and a “Delete Image” button 53O for deleting the image.

In a default state, the information has been input or selected in the corresponding input boxes or from the corresponding check boxes, based on the information stored in the property information database DB2 and the image information database DB4.

The content provider 2 can change the image property, the order type or types, and the charge in the detailed information setting window 53. More specifically, the content provider 2 corrects the information input in the input boxes on the title, the photographer, the date of photography, the photography location, the explanation, the image charge, and the delivery charge, and selects the corresponding check boxes for the property to be changed. Thereafter, the content provider 2 clicks the “Change Image Property” button 53N. In this manner, the property information on the image can be changed, and the property information database DB2 and the image information database DB4 are updated. By clicking the “Delete Image” button 53O, the image displayed in the detailed information setting window 53 can be deleted.

If the content provider 2 clicks the “Content provider Menu” button 41P displayed in the button display frame 41, a content provider management menu is shown.

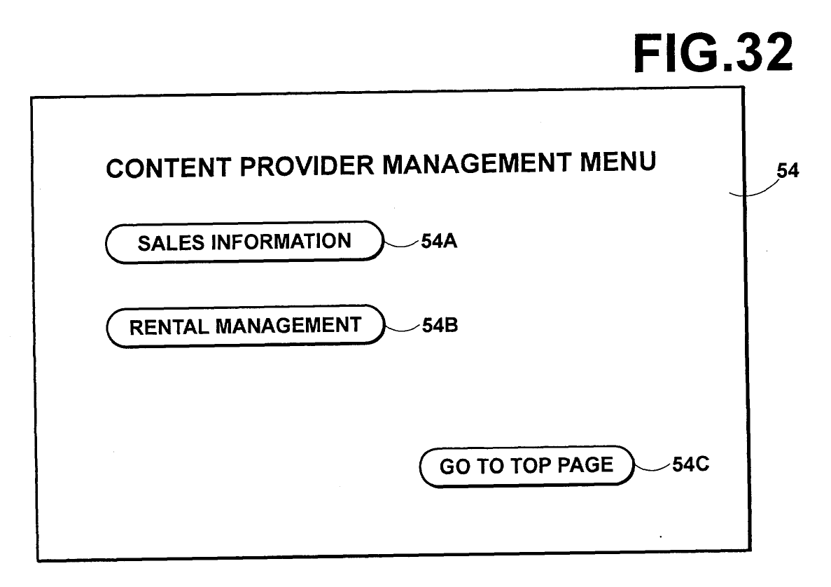

FIG. 32 shows the content provider management menu. As shown in FIG. 32, a content provider management menu 54 has “Sales Information” button 54A for displaying information on image sales, a “Rental Management” button 54B for managing image rental, and a “Go to Top Page” button 54C for going back to the top page window.

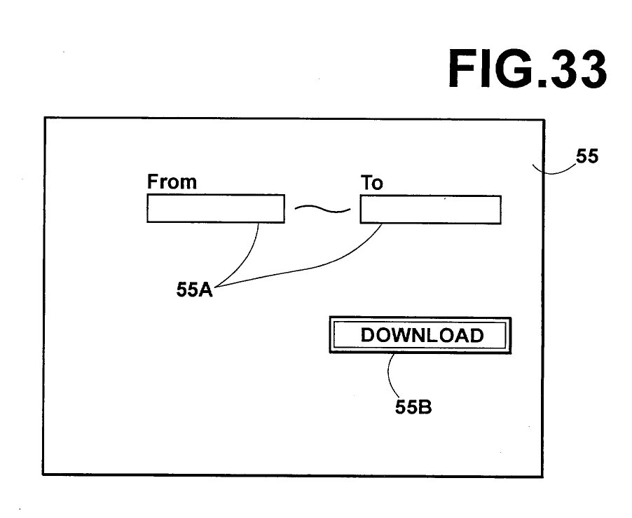

When the content provider 2 clicks the “Sales Information” button 54A, a period input window for inputting a time period for displaying the sales information is shown. FIG. 33 shows the period input window. As shown in FIG. 33, a period input window 55 has period input boxes 55A for inputting the time period, and a “Download” button 55B for downloading sales data representing the sales information for the time period. When the content provider 2 inputs the time period in the period input boxes 55A and clicks the “Download” button 55B, the sales data representing the sales information are downloaded.

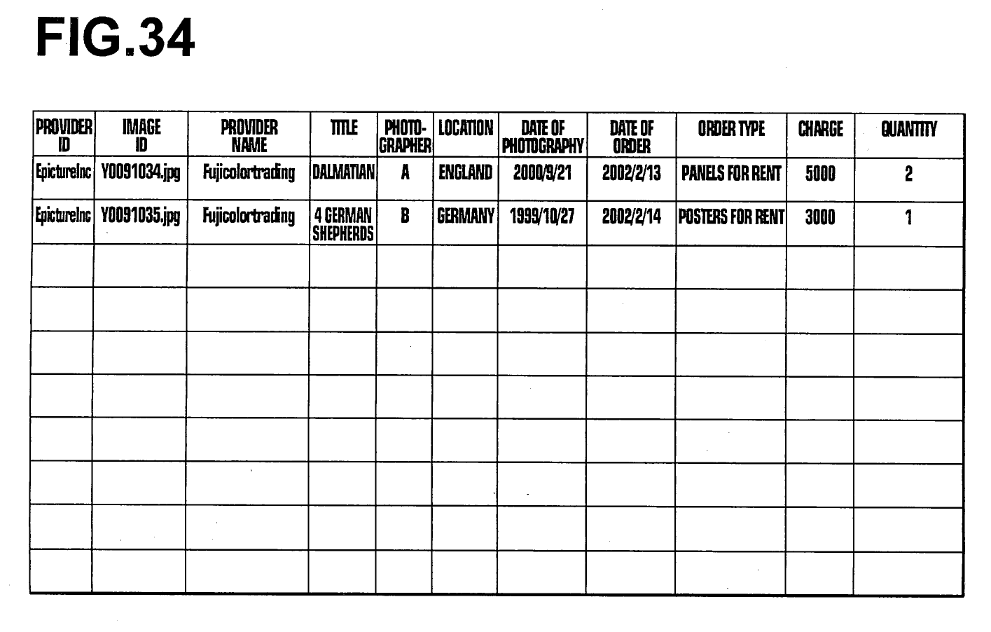

FIG. 34 shows the sales information represented by the sales data. As shown in FIG. 34, the sales information includes the provider ID, the image ID, the name of the content provider, the image title, the photographer, the location, the date of photography, the date of order, the order type used for the order, the charge, and the quantity. The content provider 2 can analyze the sales for the period by confirming the sales information.

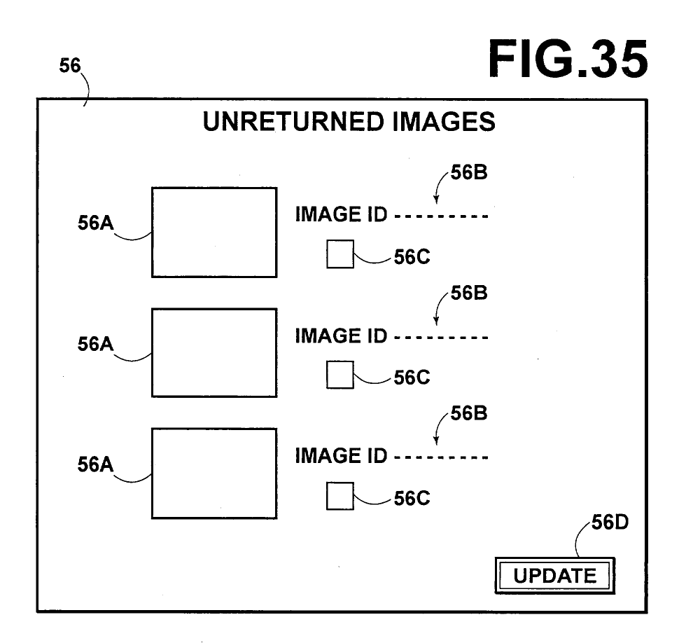

When the content provider 2 clicks the “Rental Management” button 54B, a rental management window is displayed. FIG. 35 shows the rental management window. As shown in FIG. 35, in a rental management window 36 are displayed thumbnail images 56A of unreturned images, the image ID 56B of each of the unreturned images, check boxes 56C that are selected by the content provider 2 in the case where the corresponding images have been returned, and an “Update” button 56D for updating the content of the rental management window. The content provider 2 selects the check boxes 56C for the images that have been returned, and clicks the “Update” button 56D. The content of the rental management window is then updated.

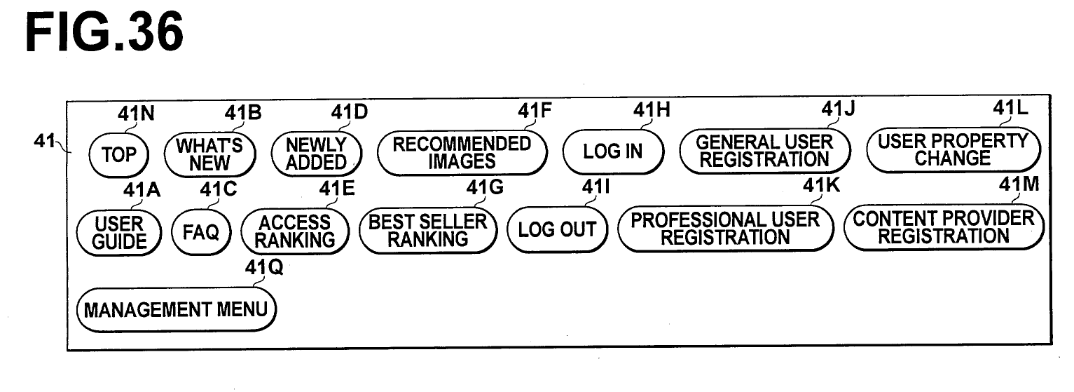

The image storage provider 1 also needs to manage the image use system 100. In this embodiment, the image storage provider 1 has management ID for managing the image use system 100. Therefore, the manager of the image storage provider 1 displays the top page window 40 shown in FIG. 11 on the personal computer 16 of the image storage server 10, and clicks the “Log In” button 41H to display a login window. The manager logs in and manages the image use system 100 by inputting the management ID and a password in the login window. When the manager logs in the image use system 100 by using the management ID, a “Management Menu” button 41Q is displayed for the manager in the button display frame 41, as shown in FIG. 36. Since the management ID is different from the user ID of each of the users 3, the “Management Menu” button 41Q in FIG. 36 is displayed only in the case where the ID that has been input is the management ID.

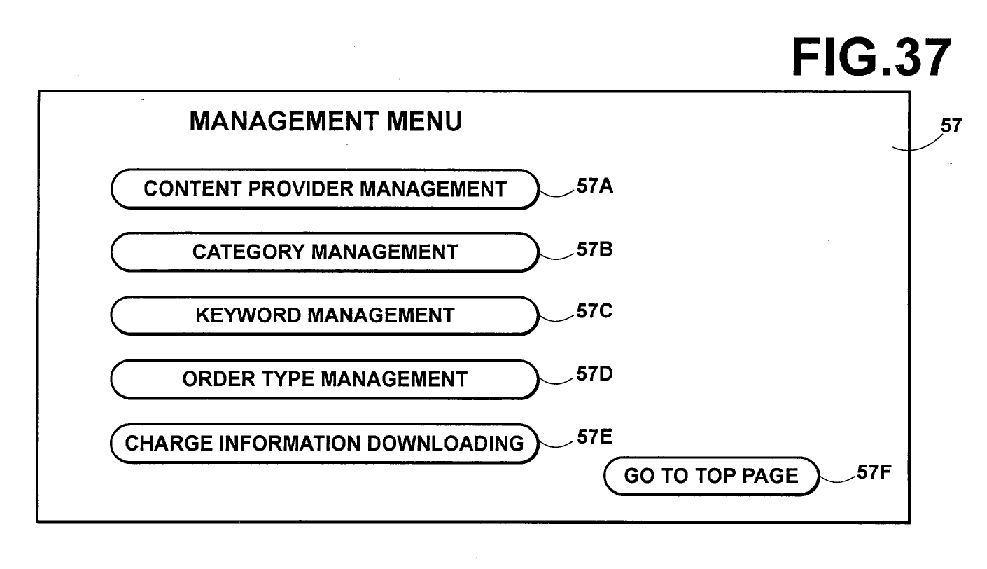

When the manager of the image storage provider 1 clicks the “Management Menu” button 41Q, a management window is displayed. FIG. 37 shows the management window. As shown in FIG. 37, in a management menu window 57 are displayed a “Content provider Management” button 57A for managing the content providers 2, a “Category Management” button 57B for managing the image categories, a “Keyword Management” button 57C for managing the story keywords, an “Order Type Management” button 57D for managing the order types, a “Charge Information Downloading” button 57E for downloading charge information, and a “Go to Top Page” button 57F for going back to the top page window.

If the manager of the image storage provider 1 clicks the “Content provider Management” button 57A in the management menu window 57, a content provider management window is displayed for managing the content providers 2. The manager can register a new content provider 2, and change or delete the registration on the content providers 2 in the content provider management window.

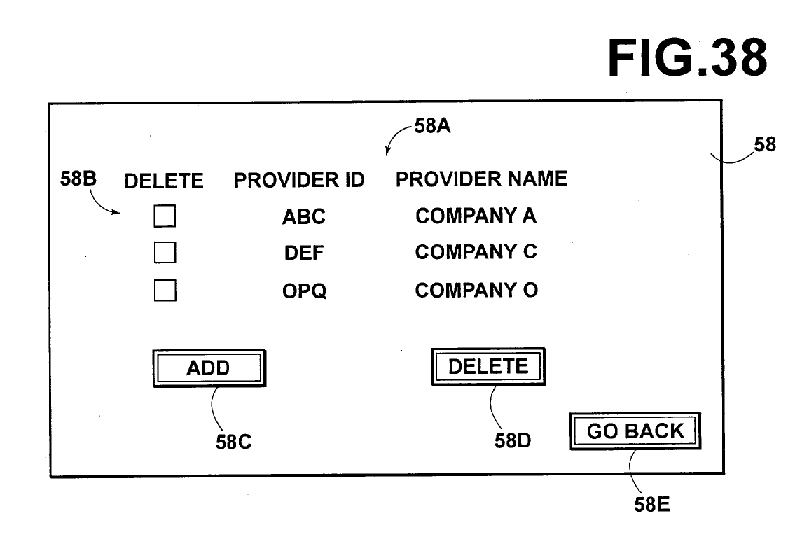

FIG. 38 shows the content provider management window. As shown in FIG. 38, in a content provider management window 58 are displayed a list display field 58A for displaying a list of the provider ID and the name of each of the content providers 2, check boxes 58B to be selected at the time of registration deletion, an “Add” button 58C for registering a new content provider 2, a “Delete” button 58D for deleting registration of any of the content providers 2, and a “Go Back” button 58E for going back to a previous window.

The manager of the image storage provider 1 clicks the provider ID of the content provider 2 whose registration is changed, in the list display field 58A. A window for changing the registration is then displayed, and the manager can change the registration by using this window.

In the case where the manager registers a new content provider 2, the manager clicks the “Add” button 58C. A registration window is displayed for the new content provider 2, and the manager can register the new content provider by using this window. The manager carries out the registration in the case where the new content provider 2 asks the registration by mail or the like.

In the case where the manager deletes the registration of any one of the content providers 2, the manager clicks the check box 58B corresponding to the content provider 2 and clicks the “Delete” button 58D. In this manner, the registration of the content provider 2 whose check box was selected can be deleted.

When new registration, registration deletion, or registration change is carried out, the content provider information database DB5 is updated. An E-mail message notifying the new registration, the registration deletion, or the registration change is sent to the corresponding content provider 2. Especially, in the case where new registration is carried out, the E-mail message to the content provider 2 includes the provider ID and the password for the content provider 2 so that the content provider 2 can immediately use the image use system 100.

When the manager of the image storage provider 1 clicks the “Category Management” button 57B in the management menu window 57, a category management window is displayed for managing the categories to which the images belong. The manager can add a new category, and can correct or delete the categories in the category management window.

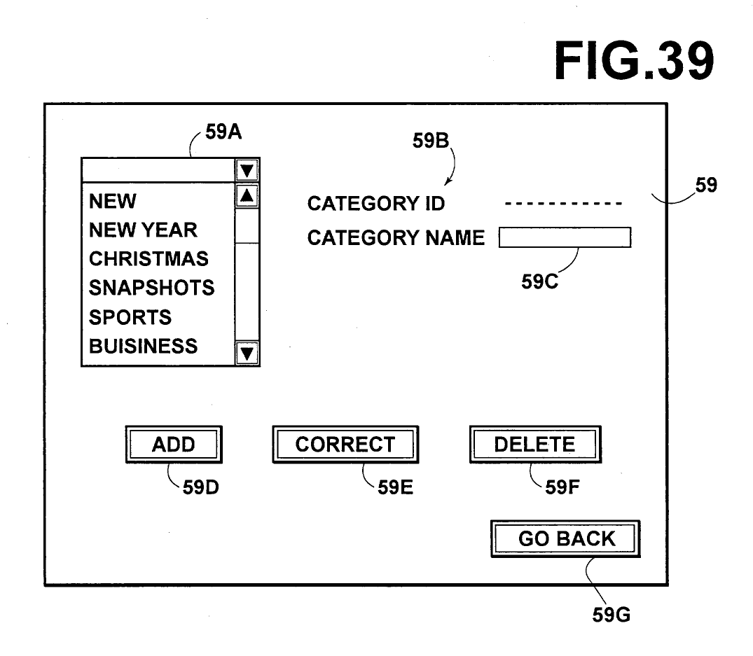

FIG. 39 shows the category management window. As shown in FIG. 39, in a category management window 59 are displayed a pull-down menu 59A for selecting one of the categories, a category ID display field 59B for displaying the ID of the selected category, a category name input box 59C for displaying the category to be managed and for inputting a new category, an “Add” button 59D for adding the new category, a “Correct” button 59E for correcting one of the categories, a “Delete” button 59F for deleting one of the categories, and a “Go Back” button 59G for going back to a previous window.

In the case where the manager of the image storage provider 1 adds a new category, the manager selects “New” in the pull-down menu 59A, and inputs the new category in the category name input box 59C. By clicking the “Add” button 59D thereafter, the manager can add the new category.

In the case where the manager corrects any one of the categories, the manager selects the category to be corrected from the pull-down menu 59A. The corresponding category ID and the category name are displayed in the category ID display field 59B and the category name input box 59C. The manager corrects the category name displayed in the category name input box 59C, and clicks the “Correct” button 59E. In this manner, the selected category can be changed.

In the case where the manager deletes any one of the categories, the manager selects the category to be deleted from the pull-down menu 59A. The corresponding category ID and the category name are displayed in the category ID display field 59B and the category name input box 59C. If the manager clicks the “Delete” button 59F, the selected category can be deleted.

When the categories are added with the new category, corrected or deleted in the above manner, the property information database DB2 and the image information database DB4 are updated.

If some of the images registered with the image storage server 10 belong to the category to be deleted, the category cannot be deleted. In this case, the images that belong to the category are searched for according to the category name, and the category to which the images belong is changed for these images in the detailed information window. Thereafter, the category can be deleted.

If the manager of the image storage provider 1 clicks the “Keyword Management” button 57C in the management menu window 57, a keyword management window is displayed for managing the story keywords. The story keywords can be added with a new story keyword, corrected, and deleted by using this window.

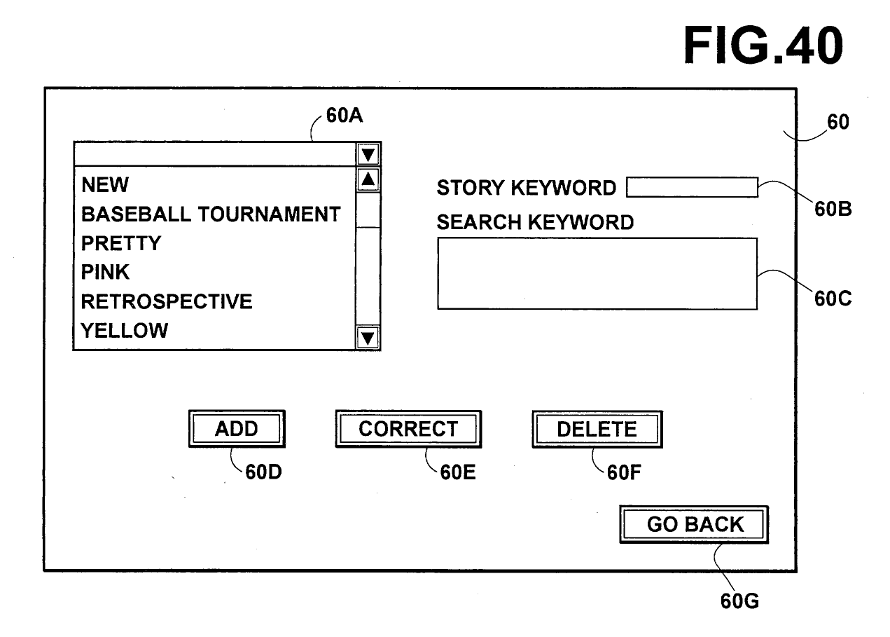

FIG. 40 shows the keyword management window. As shown in FIG. 40, in a keyword management window 60 are displayed a pull-down menu 60A for selecting one of the story keywords, a story keyword input box 60B for displaying the selected story keyword and for inputting a new story keyword, a search keyword input box 60C for displaying the search keywords related to the story keyword that has been displayed and for inputting new search keywords to be related to the story keyword that has been input, an “Add” button 60D for adding the new story keyword, a “Correct” button 60E for correcting the displayed story keyword and the displayed search keywords, a “Delete” button 60F for deleting the displayed story keyword, and a “Go Back” button 60G for going back to a previous window.

The manager of the image storage provider 1 selects “New” in the pull-down menu 60A in the case where a new story keyword is added. The manager inputs the story keyword to be added in the story keyword input box 60B, and inputs the search keywords to be related to the new story keyword in the search keyword input box 60C. By clicking the “Add” button 60D thereafter, the manager can add the new story keyword.

In the case where the manager corrects any one of the story keywords and the search keywords related thereto, the manager selects the story keyword to be corrected from the pull-down menu 60A. The selected story keyword and the search keywords related thereto are displayed in the story keyword input box 60B and the search keyword input box 60C. The story keyword displayed in the story keyword input box is corrected and the search keywords displayed in the search keyword display box are corrected, deleted or added with a new search keyword if necessary. When the manager clicks the “Correct” button 60E thereafter, the selected story keyword and the search keywords related thereto can be corrected.

In the case where the manager deletes one of the story keywords, the manager selects the story keyword to be deleted from the pull-down menu 60A. The selected story keyword and the search keywords related thereto are displayed in the story keyword input box 60B and in the search keyword input box 60C. If the manager clicks the “Delete” button 60F, the selected story keyword is deleted.

When the story keyword is added, corrected or deleted in the above manner, the keyword database DB3 and the image information database DB4 are updated.

If some of the images registered with the image storage server 10 are related to the story keyword to be deleted, the story keyword cannot be deleted. In this case, the images that are related to the story keyword are searched for according to the story keyword, and the relationship with the story keyword is deleted from these images in the detailed information window of the images. Thereafter, the story keyword can be deleted.

When the manager of the image storage provider 1 clicks the “Order Type Management” button 57D in the management window 57, an order type management window is displayed for managing the order types. The order types can be added with a new order type, corrected, and deleted by using this window.

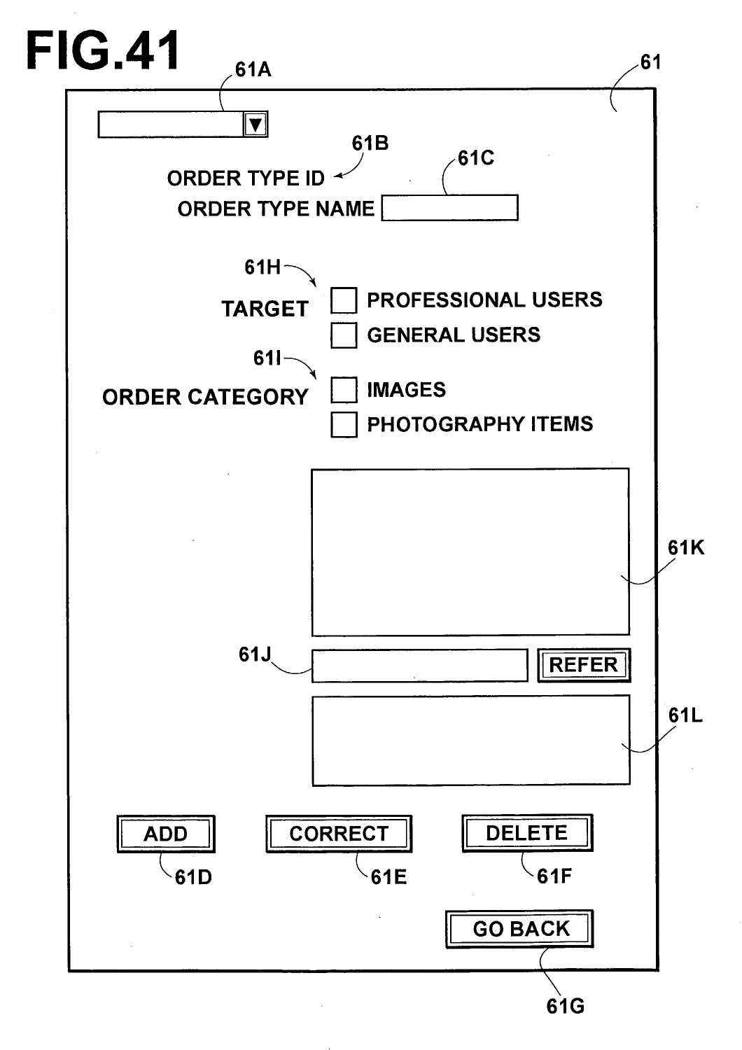

FIG. 41 shows the order type management window. As shown in FIG. 41, in an order type management window 61 are displayed a pull-down menu 61A for selecting one of the order types, an order type ID display field 61B for displaying the ID of the selected order type, an order type input box 61C for displaying the selected order type and for inputting a new order type, an “Add” button 61D for adding the new order type, a “Correct” button 61E for correcting the selected order type, a “Delete” button 61F for deleting the selected order type, a “Go Back” button 61G for going back to a previous window, check boxes 61H for selecting either professional users or general users as a target of the order type, check boxes 61I for selecting either images or photography items as an order category, a file name input box 61J for inputting the file name of one of the images of the photography items to be selected in the case where the order category is for photography items, an image display field 61K for displaying the image of the selected photography item, and a comment input box 61L for inputting a comment.

The manager of the image storage provider 1 selects “New” from the pull-down menu 61A if he/she wishes to add a new order type. The manager then inputs the name of the order type to be added in the order type input box 61C, and selects either one of the check boxes 61H or the both boxes 61H. If the manager clicks the “Add” button 61D after clicking either one of the order categories, the new order type is added.

In the case where the order category for photography items has been selected, the image for showing the new photography item to be added is necessary. Therefore, if the file name of an image data set of the photography item is input to the file name input box 61J, the image is displayed in the image display field 61K. If necessary, a comment is input in the comment input box 61L. By clicking the “Add” button 61D thereafter, the new photography item is added to the order type.

In the case where any one of the order types is corrected, the order type to be corrected is selected from the pull-down menu 61A. The order type ID and the selected order type are displayed in the order type ID display filed 61B and in the order type input box 61C. The target of order type and the order category that have been registered are selected from the check boxes 61H and 61I. The manager corrects the order type displayed in the order type input box 61C, and selects or inputs the target, the order category, the comment, and the image to be displayed in the case of photography items, if necessary. When the manager clicks the “Correct” button 61E thereafter, the selected order type can be corrected.

In the case where the manager deletes any of the order types, the manager selects the order type to be deleted from the pull-down menu 61A. The order type ID and the order type are displayed in the order type ID display field 61B and in the order type input box 61C. When the manager clicks the “Delete” button 61F thereafter, the selected order type can be deleted.

When the order type is added, corrected, or deleted in the above manner, the property information database DB2 and the image information database DB4 are updated.

When the manager of the image storage provider 1 clicks the “Download Charge Information” button 57E in the management menu window 57, a charge information downloading window is displayed for downloading charge data representing the charge information regarding the content providers 2 is displayed. The manager can download the charge data and display the data in this window.

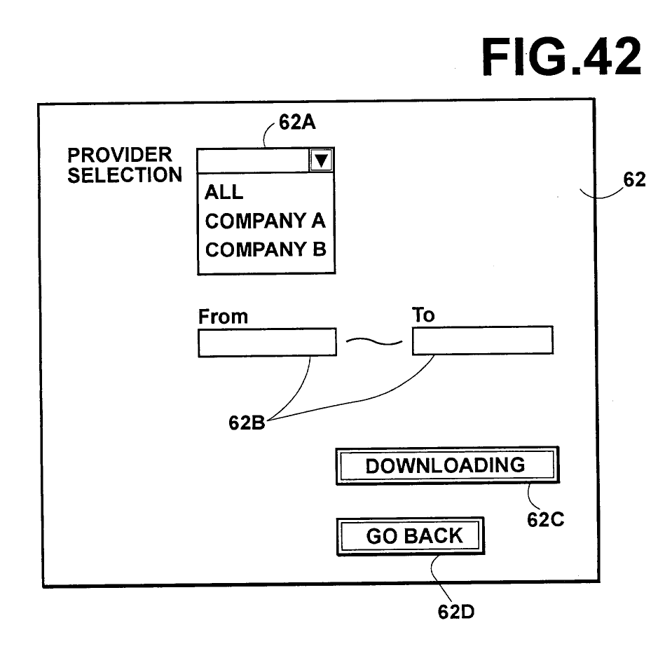

FIG. 42 shows the charge information downloading window. As shown in FIG. 42, in a charge information downloading window 62 are displayed a pull-down menu 62A for selecting a desired one of the content providers 2 for charge information downloading, period input boxes 62B for inputting a time period for obtaining the charge information, a “Download” button 62C for downloading the charge data, and a “Go Back” button 62D for going back to a previous window.

The manager of the image storage provider 1 selects the desired content provider 2 regarding which the charge information is downloaded from the pull-down menu 62A, and inputs the time period in the period input boxes 62B. By clicking the “Download” button 62C thereafter, the charge data of the selected content provider 2 can be downloaded. If the manager selects all the content providers 2 from the pull-down menu 62A, the charge information for all the content providers 2 can be downloaded.

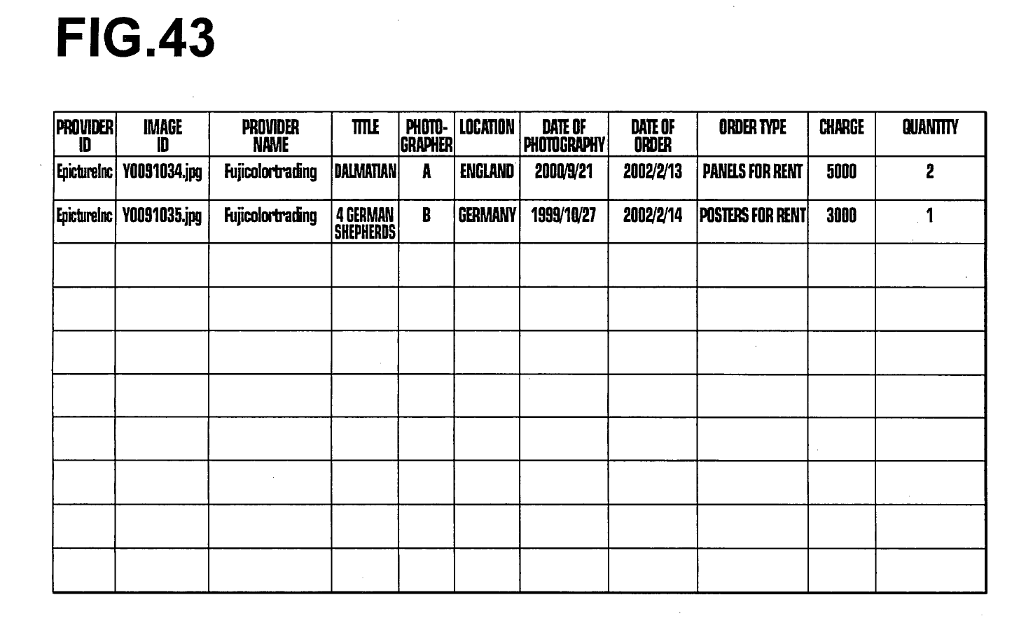

FIG. 43 shows the charge information represented by the charge data. As shown in FIG. 43, the charge information comprises items such as the provider ID, the image ID, the name of the content provider, the title of the image, the photographer, the photography location, the date of photography, the date of order, the order type, the charge, and the quantity. The image storage provider 1 can total the charges regarding each of the content providers 2 by confirming the charge information.

In the same manner as the users 3, the manager of the image storage provider 1 can also carry out an image search and display the detailed information thereof, by clicking the “For Commercial Use” button 42A or the “For Private Use” button 42B in the top page window 40. The image search window is displayed and the manager can carry out the image search and can display the detailed information. When the manager displays the detailed information at this stage, a detailed information setting window for the manager is displayed.

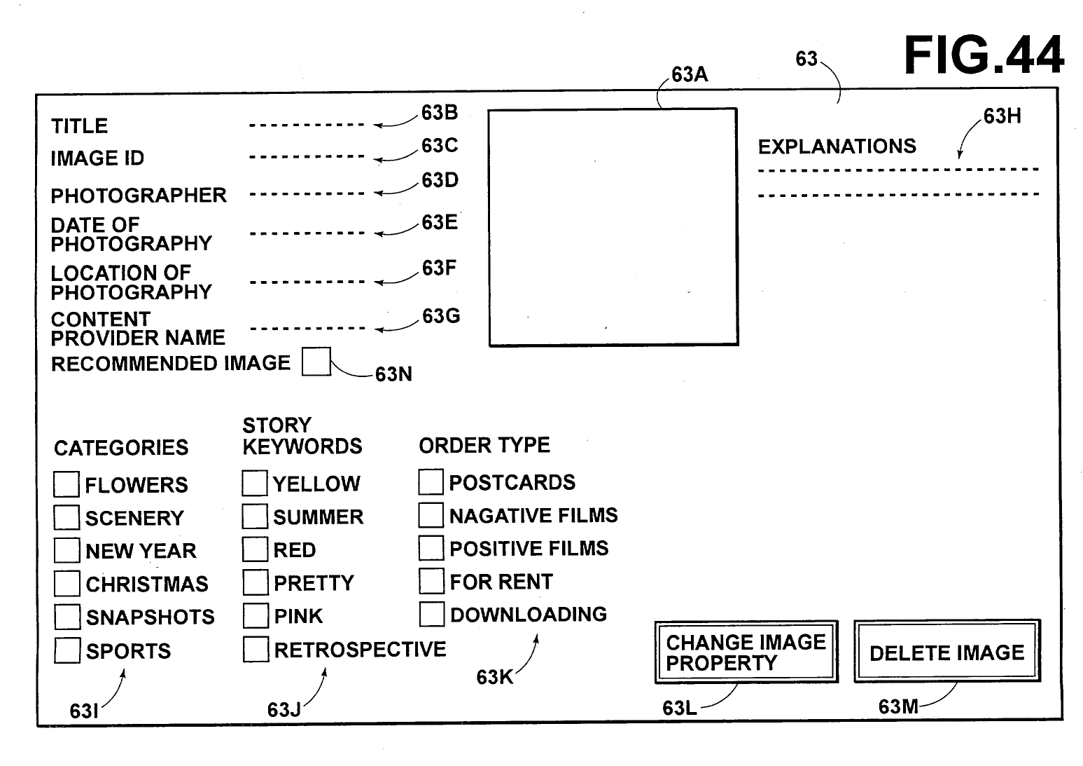

FIG. 44 shows the detailed information setting window for the manager. As shown in FIG. 44, a detailed information setting window 63 is used by the manager for setting the image property registered with the image use system 100. The detailed information setting window 63 comprises an image 63A, a title display field 63B for displaying the title of the image, an image ID display field 63C for displaying the ID of the image, a photographer display field 63D for displaying the name of the photographer of the image, a photography date display field 63E for displaying the date of photography, a photography location display field 63F for displaying the location of the photography, a provider name display field 63G for displaying the name of the content provider 2 that owns the image, an explanation display field 63H for displaying the explanation of the image, category check boxes 63I for category setting, story check boxes 63J for story keyword setting, order type check boxes 63K for order type setting, a “Change Image Property” button 63L for changing the property of the image, a “Delete Image” button 63M for deleting the image, and a check box 63N that is selected when the image is added to the recommended images.

In a default state, the check boxes have been selected based on the property information database DB2 and the image information database DB4.

The manager of the image storage provider 1 can change the category setting, the story keyword setting, and the order type setting regarding the image, add the image to the recommended images, and delete the image, in the detailed information setting window 63. In other words, the manager can change the property information of the image by clicking the “Change Image Property” button 63L after changing selection of the check boxes in the category check boxes 63I, the story check boxes 63J, and in the order type check boxes 63K and by selecting the check box 63N. By clicking the “Delete Image” button 63M, the manager can also delete the image if the image is unethical.

In the above embodiment, a story search is carried out by combining the story keywords and the search keywords related thereto. However, the story keywords may be added to the corresponding image data sets to which the search keywords related thereto have already been added respectively. In this case, when a story search is carried out, the story keywords added to the image data sets are directly referred to for the story search.

In this case, the story keywords may be added to the image data sets or embedded in the image data sets as electronic watermarks to be used for a story search.

AS has been described in the above, the search keywords are related to each of the story keywords in this embodiment. Therefore, by carrying out a story search, the corresponding image data sets can be searched for at once, based on the search keywords related to the story keyword or keywords. Therefore, the image search can be carried out efficiently.

What is claimed is:

1. An image search method comprising the steps of:
receiving an input of a desired one of representative keywords among the representative keywords each of which is prepared for representing a plurality of search keywords;
searching for a desired portion of image data sets that is related to the search keywords represented by the desired representative keyword, by referring to keyword storage means for storing the representative keywords each in relation to the search keywords, and by referring to image storage means that stores the image data sets in relation to the search keywords therefor; and
outputting a search result.

2. An image search method as defined in claim 1, wherein the step of outputting the search result is the step of outputting thumbnail images represented by the desired portion of the image data sets by being included in the search result.

3. An image search method as defined in claim 2, further comprising the steps of:
receiving selection of a desired portion of the thumbnail images;
receiving a specification of storage destination for classifying each of the selected thumbnail images;
receiving an instruction to classify the selected thumbnail images; and
storing each of the selected thumbnail images in the storage that has been specified therefor, in response to the instruction.

4. An image search method as defined in claim 1, wherein the step of receiving the input of the desired one of the representative keywords is the step of receiving the input of the desired representative keyword by displaying the representative keywords that have been prepared and by receiving selection of the desired representative keyword therefrom.

5. An image search method as defined in claim 2, wherein the step of receiving the input of the desired one of the representative keywords is the step of receiving the input of the desired representative keyword by displaying the representative keywords that have been prepared and by receiving selection of the desired representative keyword therefrom.

6. An image search method as defined in claim 3, wherein the step of receiving the input of the desired one of the representative keywords is the step of receiving the input of the desired representative keyword by displaying the representative keywords that have been prepared and by receiving selection of the desired representative keyword therefrom.

7. An image search method as defined in claim 1, further comprising the steps of receiving an input of a desired one of the search keywords and narrowing down the search result based on the search keyword that has been input.

8. An image search method as defined in claim 3, further comprising the steps of receiving an input of a desired one of the search keywords and narrowing down the search result based on the search keyword that has been input.

9. An image search method as defined in claim 4, further comprising the steps of receiving an input of a desired one of the search keywords and narrowing down the search result based on the search keyword that has been input.

10. An image search method as defined in claim 6, further comprising the steps of receiving an input of a desired one of the search keywords and narrowing down the search result based on the search keyword that has been input.

11. An image search apparatus comprising:
image storage means for storing image data sets in relation to search keywords for each of the image data sets;
keyword storage means for storing representative keywords each of which represents a plurality of the search keywords, by relating each of the representative keywords to the search keywords;
keyword input means for receiving an input of a desired one of the representative keywords;
search means for carrying out a search for a desired portion of the image data sets related to the search keywords represented by the desired representative keyword that has been input from the keyword input means, while referring to the keyword storage means and the image storage means; and
search result output means for outputting a result of the search by the search means.

12. An image search apparatus as defined in claim 11, wherein the search result output means outputs thumbnail images represented by the desired portion of the image data sets, by including the thumbnail images in the result of the search.

13. An image search apparatus as defined in claim 12, further comprising:
instruction input means for receiving selection of a desired portion of the thumbnail images, for receiving a specification of storage destination for classifying each of the selected thumbnail images, and for receiving an instruction for classifying the selected thumbnail images; and
classification means for storing the selected thumbnail images by classifying each of the selected thumbnail images in the storage that has been specified therefor, in response to the instruction that is input by the instruction input means.

14. An image search apparatus as defined in claim 11, wherein the keyword input means receives the input of the desired one of the representative keywords by displaying the representative keywords and by receiving selection of the desired representative keyword therefrom.

15. An image search apparatus as defined in claim 12, wherein the keyword input means receives the input of the desired one of the representative keywords by displaying the representative keywords and by receiving selection of the desired representative keyword therefrom.

16. An image search apparatus as defined in claim 13, wherein the keyword input means receives the input of the desired one of the representative keywords by displaying the representative keywords and by receiving selection of the desired representative keyword therefrom.

17. An image search apparatus as defined in claim 11, wherein the keyword input means further receives an input of a desired one of the search keywords and the search means narrows down the search result, based on the search keyword that has been input.

18. An image search apparatus as defined in claim 13, wherein the keyword input means further receives an input of a desired one of the search keywords and the search means narrows down the search result, based on the search keyword that has been input.

19. An image search apparatus as defined in claim 14, wherein the keyword input means further receives an input of a desired one of the search keywords and the search means narrows down the search result, based on the search keyword that has been input.

20. An image search apparatus as defined in claim 16, wherein the keyword input means further receives an input of a desired one of the search keywords and the search means narrows down the search result, based on the search keyword that has been input.

21. A program comprising the steps of:
receiving an input of a desired one of representative keywords among the representative keywords each of which is prepared for representing a plurality of search keywords;
searching for a desired portion of image data sets that is related to the search keywords represented by the desired representative keyword, by referring to keyword storage means for storing the representative keywords each in relation to the search keywords, and by referring to image storage means that stores the image data sets in relation to the search keywords therefor; and
outputting a search result.

22. A program as defined in claim 21, wherein the step of outputting the search result is the step of outputting thumbnail images represented by the desired portion of the image data sets by being included in the search result.

23. A program as defined in claim 22, further comprising the steps of:
receiving selection of a desired portion of the thumbnail images;
receiving a specification of storage destination for classifying each of the selected thumbnail images;
receiving an instruction to classify the selected thumbnail images; and
storing each of the selected thumbnail images in the storage that has been specified therefor, in response to the instruction.

24. A program as defined in claim 21, wherein the step of receiving the input of the desired one of the representative keywords is the step of receiving the input of the desired representative keyword by displaying the representative keywords that have been prepared and by receiving selection of the desired representative keyword therefrom.

25. A program as defined in claim 22, wherein the step of receiving the input of the desired one of the representative keywords is the step of receiving the input of the desired representative keyword by displaying the representative keywords that have been prepared and by receiving selection of the desired representative keyword therefrom.

26. A program as defined in claim 23, wherein the step of receiving the input of the desired one of the representative keywords is the step of receiving the input of the desired representative keyword by displaying the representative keywords that have been prepared and by receiving selection of the desired representative keyword therefrom.

27. A program as defined in claim 21, further comprising the steps of receiving an input of a desired one of the search keywords and narrowing down the search result based on the search keyword that has been input.

28. A program as defined in claim 23, further comprising the steps of receiving an input of a desired one of the search keywords and narrowing down the search result based on the search keyword that has been input.

29. A program as defined in claim 24, further comprising the steps of receiving an input of a desired one of the search keywords and narrowing down the search result based on the search keyword that has been input.

30. A program as defined in claim 26, further comprising the steps of receiving an input of a desired one of the search keywords and narrowing down the search result based on the search keyword that has been input.
